(19) United States
(12) Patent Application Publication
(10) Pub. No.: US 2014/0123053 A1
(43) Pub. Date: May 1, 2014

(54) DISPLAY TERMINAL DEVICE, DISPLAY SCREEN SHARING SYSTEM, AND DISPLAY SCREEN SHARING METHOD

(71) Applicant: FUNAI ELECTRIC CO., LTD., Osaka (JP)

(72) Inventors: Takeshi NAKADA, Osaka (JP); Seiji TSUKADA, Osaka (JP); Yusuke TAKENAKA, Osaka (JP); Makoto HATA, Osaka (JP)

(73) Assignee: FUNAI ELECTRIC CO., LTD., Osaka (JP)

(21) Appl. No.: 14/048,229

(22) Filed: Oct. 8, 2013

(30) Foreign Application Priority Data
Oct. 25, 2012 (JP) 2012-236131
Oct. 25, 2012 (JP) 2012-236139
Sep. 9, 2013 (JP) 2013-186067

(51) Int. Cl. G06F 3/0481

(52) U.S. Cl. CPC G06F 3/0481
USPC 715/778

(57) ABSTRACT

A display terminal device displays objects arranged in a virtual space on a display device. The display terminal device generates an object identifier indicating an object entered by a user such that the object identifier includes a user identifier. The generated object identifier is, along with the object, transmitted to a drawing device. The display terminal device saves an object and an object identifier received from the drawing device until receiving the transmitted object from the drawing device. A display screen of the display device is refreshed to display the object received from the drawing device.

The present application is based on, and claims priority from, Japanese Patent Application No. 2012-236131 filed on Oct. 25, 2012, Japanese Patent Application No. 2012-236139 filed on Oct. 25, 2012, and Japanese Patent Application No. 2013-186067 filed on Sep. 9, 2013, the disclosure of which is hereby incorporated by reference herein in its entirety.

### BACKGROUND OF THE INVENTION

1. Field of the Invention

The present invention relates to a display terminal device, a display screen sharing system, and a display screen sharing method, and more particularly to a method and a system for sharing a display screen among a plurality of display terminal devices.

2. Description of Related Art

Conventionally, there are known drawing systems in which a display screen administered by a drawing device are shared among a plurality of display terminal devices connected to the drawing device across a network. In such a drawing system, in general, users are designated on an area by area basis to be in charge of working in respective areas; thus, it does not occur that a plurality of users work in one area concurrently. That is, one user works in each area, and therefore displaying objects chronologically according to an operation history does not cause the user to feel uncomfortable.

On the other hand, there are also known CAD systems, like the one disclosed in Japanese Patent No. 2951312, which allow a plurality of designers to work in a team. In such a system, each designer can freely arrange objects in a drawing space, and can freely modify, delete, and otherwise handle objects so arranged. Not only are objects arranged by one designer displayed immediately on his own display terminal device, but objects arranged by another designer are also transmitted from a drawing device to the first designer's display terminal device across a network. Thus, a time lag occurs between the display of an object arranged by the first designer and the display of an object arranged by the second designer.

Moreover, while an object arranged by a designer is displayed in the foreground on the display screen, it can occur that, during the period after the arranged objet is transmitted to the drawing device until it is received back by the designer's own display terminal device, an object arranged by another designer is received.

Inconveniently, however, if objects are displayed in the order in which they are received, a display condition may arise in which an already displayed object disappears by being overwritten, the object appearing as if to have been lost. This inconvenience is not addressed by Japanese Patent No. 2951312.

### SUMMARY OF THE INVENTION

Devised to address the inconvenience mentioned above, the present invention aims to prevent a user from feeling uneasy about apparent loss of already displayed object data upon display of object data received from a drawing device.

To achieve the above object, according to one aspect of the present invention, a display screen sharing system includes a plurality of display terminal devices and a drawing device connected to the plurality of display terminal devices.

Each display terminal device displays object data arranged in a virtual space on a display device. The display terminal device is provided with an identifier generator, a transmitter, a receiver, a reservoir, and a display controller. The identifier generator generates an object identifier indicating object data entered by a user of the display terminal device such that the object identifier includes a user identifier indicating the user. The transmitter transmits object data entered by the user and the object identifier generated by the identifier generator to the drawing device. The receiver receives object data and an object identifier indicating the object data from the drawing device. The reservoir saves the object data and the object identifier received from the drawing device until the object data transmitted from the transmitter is received by the receiver. The display controller refreshes a display screen of the display device to display the object data received by receiver.

With this display terminal device, until the object data transmitted by the transmitter is received by the receiver, the object data and the object identifier received from the drawing device are saved in the reservoir, and the display screen of the display device is not refreshed but is retained. When the transmitted object data is received by the receiver, the display screen of the display device is refreshed to display the received object data. Thus, even when the display controller refreshes the display screen of the display device, it is possible to display the object data entered by the user of the display terminal device in the foreground (topmost layer). In this way, even when the object data received from the drawing device is displayed, it is possible to prevent the user from feeling uneasy about apparent loss of already displayed object data.

The drawing device includes a storage for storing a drawing database and an operation history database, and a controller. In the drawing database, object data arranged in the virtual space is registered. In the operation history database, records of individual user operations executed on the object data are accumulated. The controller edits the drawing database and the operation history database based on commands corresponding to user operations. The controller also displays the object data registered in the drawing database on the display device. The records accumulated in the operation history database each include a command indicating a user operation, object data after the user operation, a reverse command for a reverse operation for cancelling the user operation, and object data before the user operation. When the command for canceling the user operation is executed, the controller executes the reverse command to display the object data before the user operation on the display device.

With this drawing device, the records accumulated in the operation history database each include a command, object data after a user operation, a reverse command, and object data before the user operation. The command indicates a user operation executed on the object data, and the reverse command indicates a reverse operation for cancelling the user operation. Thus, when the command for cancelling the user operation is executed, it is possible, without searching the entire operation history database, to execute the reverse command to display the object data before the user operation on the display device. In this way, it is possible to synchronize the display screen quickly and perform drawing quickly.

According to another aspect of the present invention, a display screen sharing method allows sharing of a display screen among a plurality of display terminal devices connected to a drawing device having a drawing database in which object data arranged in a virtual space is registered.

In each of the display terminal devices, an object identifier indicating object data entered by a user is generated such that the object identifier includes a user identifier indicating the user. The object data entered by the user and the generated object identifier are transmitted to the drawing device. Moreover, object data and an object identifier indicating the object data are received from the drawing device. Here, the object data and the object identifier received from the drawing device are saved until the object data transmitted to the drawing device is received. Then, a display screen on a display device is refreshed to display the object data received in the receiving step.

In the drawing device, the drawing database is edited based on a command corresponding to a user operation executed on the object data arranged in the virtual space. Moreover, an operation history database, in which records of individual user operations are accumulated, is edited based on a command corresponding to a user operation. The records each include a command indicating a user operation, object data after the user operation, a reverse command indicating a reverse operation for canceling the user operation, and object data before the user operation. Then, the object data registered in the drawing database is displayed on the display device. Furthermore, when the command for canceling the user operation is executed, the reverse command is executed to display the object data before the user operation on the display device.

Further features and advantages of the present invention will become apparent from the description of embodiments given below.

### BRIEF DESCRIPTION OF THE DRAWINGS

FIG. 1 is a schematic configuration diagram of a distributed drawing system embodying the present invention.

FIG. 2 is a schematic configuration diagram of a drawing server;

FIG. 3 is a schematic configuration diagram of a client;

FIG. 4 is a diagram showing an example of a display screen on a client;

FIG. 5 is a diagram showing an example of how a stroke color selection palette and a stroke width selection palette are displayed;

FIG. 6 is a diagram showing an example of how a stroke type selection palette is displayed;

FIG. 7 is a diagram showing an example of how a drawing palette is displayed;

FIG. 8 is a diagram showing an example of how an undo palette is displayed;

FIG. 9 is a data structure diagram showing an example of a drawing data array and a drawing backup array;

FIG. 10 is a data structure diagram showing an example of an overall operation history array;

FIG. 11 is a data structure diagram showing an example of an undo history array;

FIG. 12 is a data structure diagram showing an example of a drawing space token array;

FIG. 13 is a data structure diagram showing an example of a drawing space connection array;

FIG. 14 is a table showing an example of user operations in a drawing space;

FIG. 15A is a diagram showing an example of data in which a free-hand geometric object is expressed;

FIG. 15B is a diagram showing an example of data in which a straight line object is expressed;

FIG. 15C is a diagram showing an example of data in which a circle object is expressed;

FIG. 15D is a diagram showing an example of data in which a rectangle object is expressed;

FIG. 15E is a diagram showing an example of data in which a triangle object is expressed;

FIG. 15F is a diagram showing an example of data in which a text object is expressed.

FIG. 16 is a sequence diagram of user log-in authentication;

FIG. 17 is a diagram showing an example of a log-in screen on a client;

FIG. 18 is a sequence diagram of client admission;

FIG. 19 is a sequence diagram of a geometry addition process;

FIG. 20 is a flow chart showing operation of a drawing server in a geometry addition process;

FIG. 21 is a sequence diagram of a geometry modification process;

FIG. 22 is a flow chart showing operation of a drawing server in a geometry modification process;

FIG. 23 is a sequence diagram of a geometry deletion process;

FIG. 24 is a flow chart showing operation of a drawing server in a geometry deletion process;

FIG. 25 is a sequence diagram of a complete deletion process;

FIG. 26 is a flow chart showing operation of a drawing server in a complete deletion process;

FIG. 27 is a flow chart showing a method of setting an undoing command and undoing object data;

FIG. 28 is a flow chart of an undo process on a drawing server;

FIG. 29 is a flow chart of a redo process on a drawing server;

FIG. 30 is a sequence diagram illustrating how a display screen is refreshed on different clients in a first embodiment; and

FIG. 31 is a sequence diagram illustrating how a display screen is refreshed on different clients in a second embodiment.

### DETAILED DESCRIPTION OF PREFERRED EMBODIMENTS

Hereinafter, embodiments of the present invention will be described with reference to the accompanying drawings, with a distributed drawing system 1 taken as an example.

### First Embodiment

### System Configuration

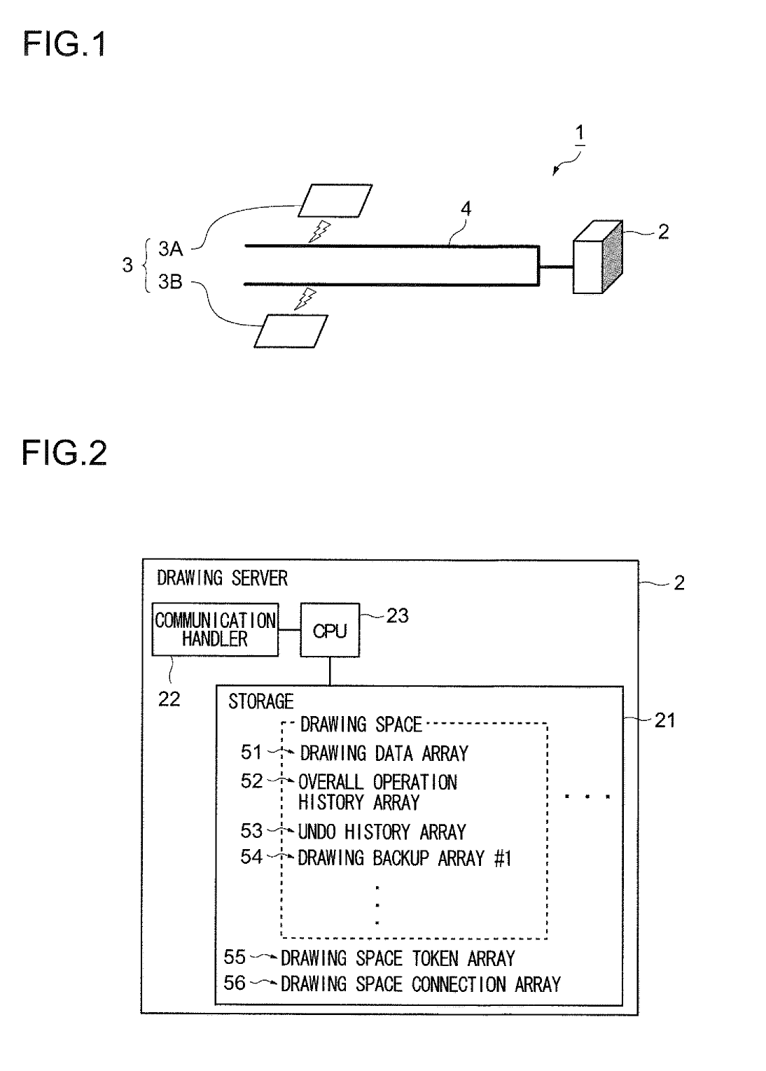

FIG. 1 is a schematic configuration diagram of a distributed drawing system embodying the present invention. The distributed drawing system 1 is an example of a display screen sharing system in which object data arranged in a drawing space (virtual space) is displayed on a plurality of clients 3 connected to a drawing server 2. The drawing space is administered by the drawing server 2, and one or more users can participate in it. As shown in FIG. 1, the plurality of clients 3 are connected to the drawing server 2 across a network 4. The network 4 is, for example, a wireless LAN, a wired LAN, or a mobile communication network. The number of clients 3 that are connected to the drawing server 2 is not limited to that in the example shown in FIG. 1; at least one client 3 needs to be connected to it.

### (Drawing Server Configuration)

Next, the configuration of the drawing server 2 will be described. The drawing server 2 is an example of a drawing device functioning as a server device that administers one or more drawing spaces and that shares a drawing space with a client 3 used by a participation-authorized user. FIG. 2 is a schematic configuration diagram of the drawing server. A shown in FIG. 2, the drawing server 2 is provided with a storage 21, a communication handler 22, and a CPU 23.

The storage 21 is a nonvolatile storage medium, and stores various kinds of programs and control information used in different parts of the drawing server 2. The storage 21 also stores data on the drawing spaces administered by the drawing server 2, various data arrays used in drawing spaces, user data on users who can participate in drawing spaces, etc. The data arrays include, for example, a drawing data array 51, an overall operation history array 52, an undo history array 53, a drawing backup array 54, a drawing space token array 55, a drawing space connection array 56, etc. The drawing data array 51 contains object data arranged in drawing spaces. The overall operation history array 52 contains records of individual user operations executed on object data. The drawing data array 51, the overall operation history array 52, the undo history array 53, and the drawing backup array 54 are generated for each drawing space. These data arrays will be described in detail later. The user data contains, for example, user IDs for identifying participation-authorized users and passwords for authenticating those users.

The communication handler 22 is a communication interface that exchanges data with the clients 3 across the network 4.

The CPU 23 is a controller that, by using programs and control information stored in the storage 21, controls different parts of the drawing server 2. The CPU 23 also edits and otherwise handles data stored in the storage 21. The CPU 23 edits, in particular, the drawing data array 51, the overall operation history array 52, the undo history array 53, etc. according to commands corresponding to various user operations that the communication handler 22 receives from the clients 3. The CPU 23 then controls the clients 3 so that these display the object data registered in the drawing data array 51. In addition, the CPU 23 checks or otherwise handles various kinds of identifiers (identifying information) such as object IDs and user IDs.

### (Client Configuration)

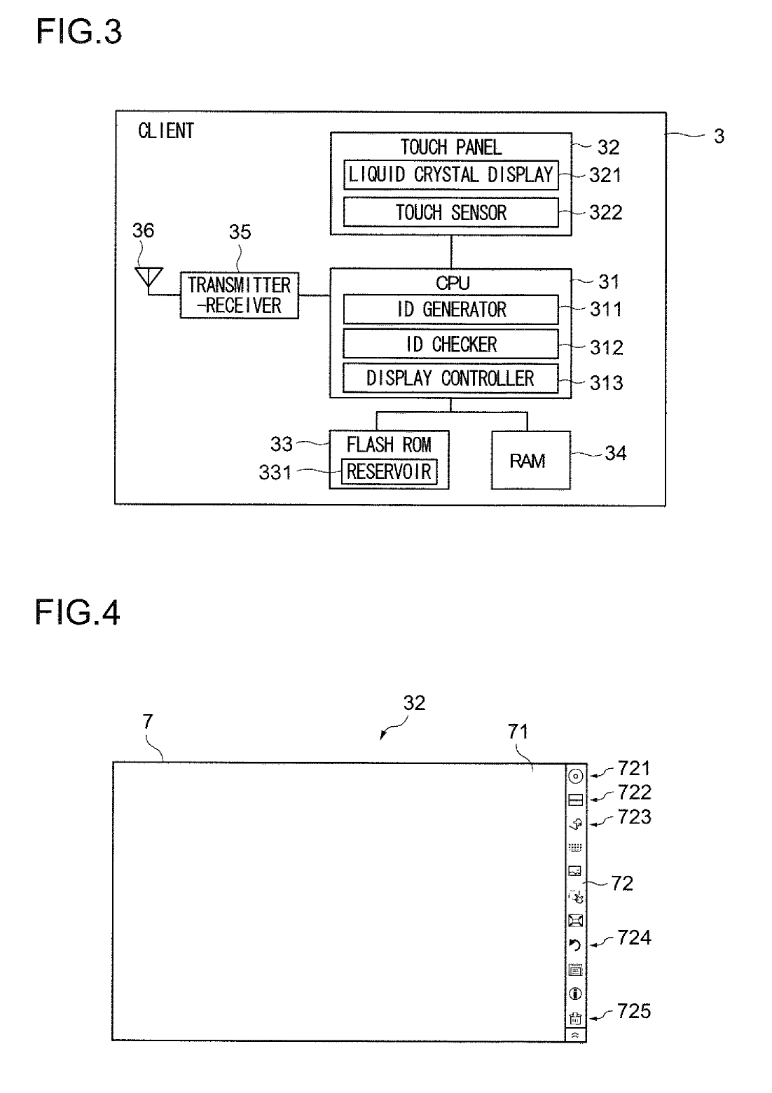

Next, the configuration of the clients 3 will be described. A client 3 is a display terminal device functioning as a client device (or an input/output device) that is used by user authorized to participate in a drawing space administered by the drawing server 2. FIG. 3 is a schematic configuration diagram of the client. As shown in FIG. 3, the client 3 is provided with a CPU 31, a touch panel 32, a flash ROM 33, a RAM 34, a transmitter-receiver 35, and a wireless LAN antenna 36. The client 3 may further be provided with a physical input device such as a keyboard and a mouse.

The CPU 31 is a controller that, by using programs, control information, and the like stored in the flash ROM 33, controls different parts of the client 3. The CPU 31 includes an ID generator 311, an ID checker 312, and a display controller 313.

The ID generator 311 is an identifier (identification information) generator that generates object IDs which each uniquely indicate a particular set of object data. The ID generator 311 generates an object ID indicating object data entered by a user of the client 3 such that the object ID contains a user ID indicating the user of the client 3. The object ID here contains a character string of a unique user ID indicating the user who uses the client 3 along with a characteristic value unique to the user ID.

The ID checker 312 is an identifier checker that checks identifiers such as object IDs and user IDs. When the transmitter-receiver 35 receives data (for example, a command, an object ID, or object data) from the drawing server 2, the ID checker 312 extracts a user ID from the received object ID. Then, the ID checker 312 checks whether or not the extracted user ID matches the user ID of the user of the client 3.

The display controller 313 controls display on a liquid crystal display 321, and refreshes the display screen 7 of the liquid crystal display 321 so that the object data received by the transmitter-receiver 35 is displayed there. If the ID checker 312 finds the IDs to mismatch, the display controller 313 temporarily stores the object data received from the drawing server 2 in a reservoir 331, which will be described later. On the other hand, if the ID checker 312 finds the IDs to match, the display controller 313 refreshes the display screen 7 of the liquid crystal display 321 to display the object data temporarily stored in the reservoir 331 on the liquid crystal display 321. At this time, the display controller 313 deletes, out of the objects already displayed on the display screen 7, the one indicated by the object ID received from the drawing server 2. Subsequently, the display controller 313 displays all the object data temporarily stored in the reservoir 331 along with the object data that the transmitter-receiver 35 received from the drawing server 2, in an object display region 71, which will be described later, on the display screen 7. These sets of object data are displayed in the order in which the transmitter-receiver 35 received them from the drawing server 2.

In this way, even when the display screen 7 is refreshed, the object data transmitted to the drawing server 2 can be displayed in the topmost layer (in the foreground). Thus, even when the object data received from the drawing server 2 is displayed, it is possible to save the user from feeling uneasy about apparent loss of already displayed object data. When the display screen 7 is refreshed, the object data received from the drawing server 2 (that is, the object data stored in the reservoir 331) are displayed all together. Thus, the object data can be displayed in a single display operation. Compared with where a plurality of display operations are involved, it is possible to suppress flicker on the display screen 7 and to save the user from feeling uncomfortable.

Suppose that the client 3 is in a state where the transmitter-receiver 35 has completed transmission of all object data to be transmitted to the drawing server 2 and in addition the transmitter-receiver 35 has been able to complete reception from the drawing server 2 of all the object data transmitted from the client 3. In this case, the display controller 313 displays the object data received from the drawing server 2 on the liquid crystal display 321. Incidentally, this operation is performed irrespective of the user ID indicated by the object ID of the object data. That is, in this operation, the ID checker 312 does not check the user ID.

In this way, in a state where the transmitter-receiver 35 has completed transmission of all object data to be transmitted to the drawing server 2 and in addition the transmitter-receiver 35 has been able to complete reception from the drawing server 2 of all the object data transmitted from the client 3, the client 3 can immediately display the object data received from the drawing server 2 on the liquid crystal display 321. Thus, at this time, the client 3 can quickly refresh the display screen 7.

When the transmitter-receiver 35 receives object data from the drawing server 2 during a predetermined period (for example, 0.5 seconds) after the refreshing of the display screen 7, the ID checker 312 stores the object data in the reservoir 331. This operation is performed irrespective of the user ID indicated by the object ID of the object data received from the drawing server 2. That is, in this operation, the ID checker 312 does not check the user ID.

In this way, even if the period that elapses until the object data transmitted to the drawing server 2 is received from the drawing server 2 is shorter than the predetermined period (for example, 0.5 seconds), the display screen 7 can be prevented from being refreshed to display the temporarily stored object data. It is thus possible to more reliably save the user from feeling uneasy about apparent loss of already displayed object data from the display screen 7 upon refreshing of the display screen 7. It is also possible to more effectively suppress flicker or the like due to refreshing of the display screen 7.

Next, the touch panel 32 is an example of a display-input device that accepts user input through touch operations by a user. For example, when the user's finger or a touch pen touches the display screen 7, the touch panel 32 accepts user input indicated through the touch operation. The touch panel 32 includes a liquid crystal display 321 and a touch sensor 322. The liquid crystal display 321 is an example of a display device that displays object data in a drawing space in which a user who uses the client 3 participates. The touch sensor 322 is an example of an input device that accepts user operations. The client 3 may be provided with, instead of the touch panel 32, a display device like the liquid crystal display 321 and an input device such as a keyboard and a mouse separately.

The flash ROM 33 is a nonvolatile storage medium, and stores various kinds of programs and control information used in different parts of the client 3, data for displaying drawing spaces, etc. The flash ROM 33 includes a reservoir 331 that temporality stores data (for example, commands, object data, object IDs, etc.) that the transmitter-receiver 35 has received from the drawing server 2. The reservoir 331 may be provided not in the flash ROM 33 but in the RAM 34.

The RAM 34 is a volatile storage medium.

The transmitter-receiver 35 is a communication interface that is connected to the network 4 via the wireless LAN antenna 36, and exchanges various kinds of data with the drawing server 2. For example, the transmitter-receiver 35 functions as a transmitter that transmits a command indicating a user operation executed on object data and the object data after the user operations along with its object ID to the drawing server 2. The transmitter-receiver 35 also functions as a receiver that receives a command and object data along with its object ID from the drawing server 2. In this embodiment, the transmitter-receiver 35 functions as both a transmitter and a receiver; instead, a transmitter and a receiver may be provided separately.

### (Client Display Screen)

Next, the display screen 7 in a drawing space on the touch panel 32 of each client 3 will be described. FIG. 4 is a diagram showing an example of the display screen on a client. As shown in FIG. 4, the display screen 7 includes an object display region 71 and a menu display region 72.

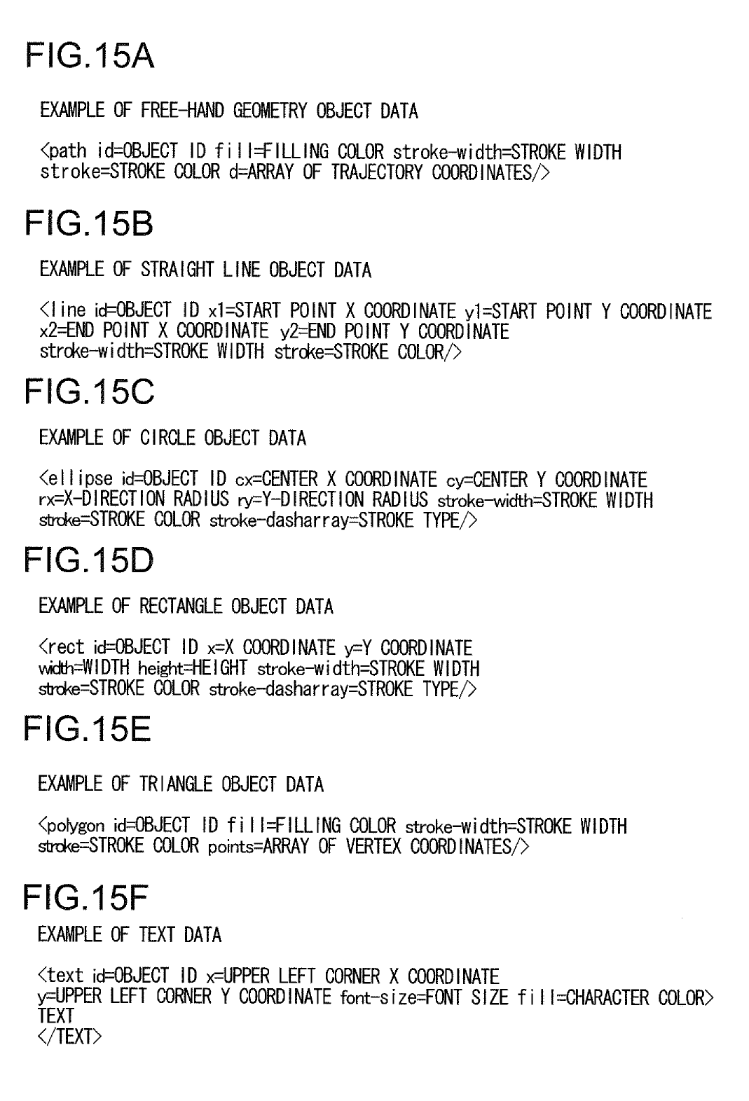

The object display region 71 is a region where object data of a drawing space in which the user of the client 3 participates is displayed. In this drawing space, for example, objects such as geometric objects, text objects, and image objects can be arranged (see FIGS. 15A to 15F, which will be described later). Geometric objects include predetermined geometric figures (circles, polygons, their solid (filled) versions, straight lines, arrows, etc.) as well as free-hand (hand-drawn) geometries entered through touch operations by the user on the touch panel 32. In the following description, object data are often referred to simply as “objects,” and geometric objects simply as “geometries.”

The menu display region 72 is a region where a drawing menu is displayed in which icons for handling objects arranged in the drawing space are arranged. The drawing menu includes a stroke color selection button 721, a stroke type selection button 722, a drawing tool button 723, an undo button 724, and a clear button 725. The drawing menu also includes a text mode button, an image input button, a selection mode button, a canvas edit button, a snapshot button, and drawing space information display button. Incidentally, the text mode button is an icon for arranging entered text data. On the other hand, the image input button is an icon for arranging desired image data.

The stroke color selection button 721 is an icon for selecting the color of the strokes of a geometry in the drawing space. When the user selects the stroke color selection button 721, near where it is displayed, a stroke color selection palette 7211 and a stroke width selection palette 7212 are displayed. FIG. 5 is a diagram showing an example of how a stroke color selection palette and a stroke width selection palette are displayed. As shown in FIG. 5, the stroke color selection palette 7211 shows a plurality of color samples, and the stroke width selection palette 7212 shows a plurality of thickness samples. With a desired geometry in the drawing space selected, the user can, by selecting one of the color samples through a touch operation, make the strokes forming the selected geometry the same color as the selected color sample. Likewise, by selecting one of the thickness samples, the user can make the strokes of the selected geometry as thick as the selected thickness sample.

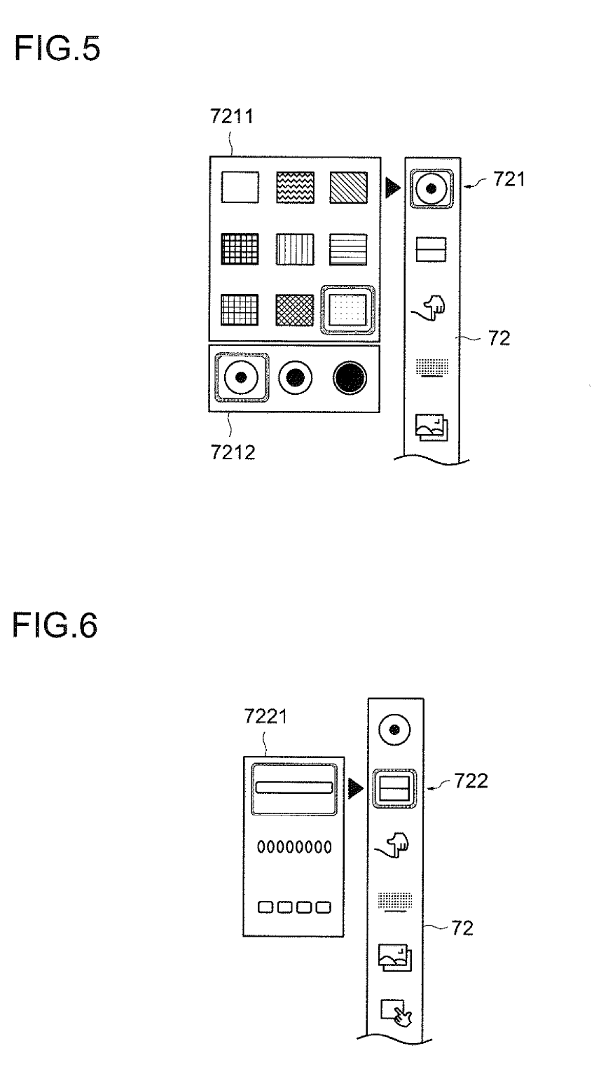

The stroke type selection button 722 is an icon for selecting the type (for example, solid, broken, dash-and-dot, etc.) of the strokes of a geometry in the drawing space. When the stroke type selection button 722 is selected, near where it is displayed, a stroke type selection palette 7221 is displayed. FIG. 6 is a diagram showing an example of how a stroke type selection palette is displayed. As shown in FIG. 6, the stroke type selection palette 7221 shows a plurality of stroke samples. With a desired geometry in the drawing space selected, the user can, by selecting one of the stroke samples through a touch operation, make the strokes forming the selected geometry the same type as the selected stroke sample.

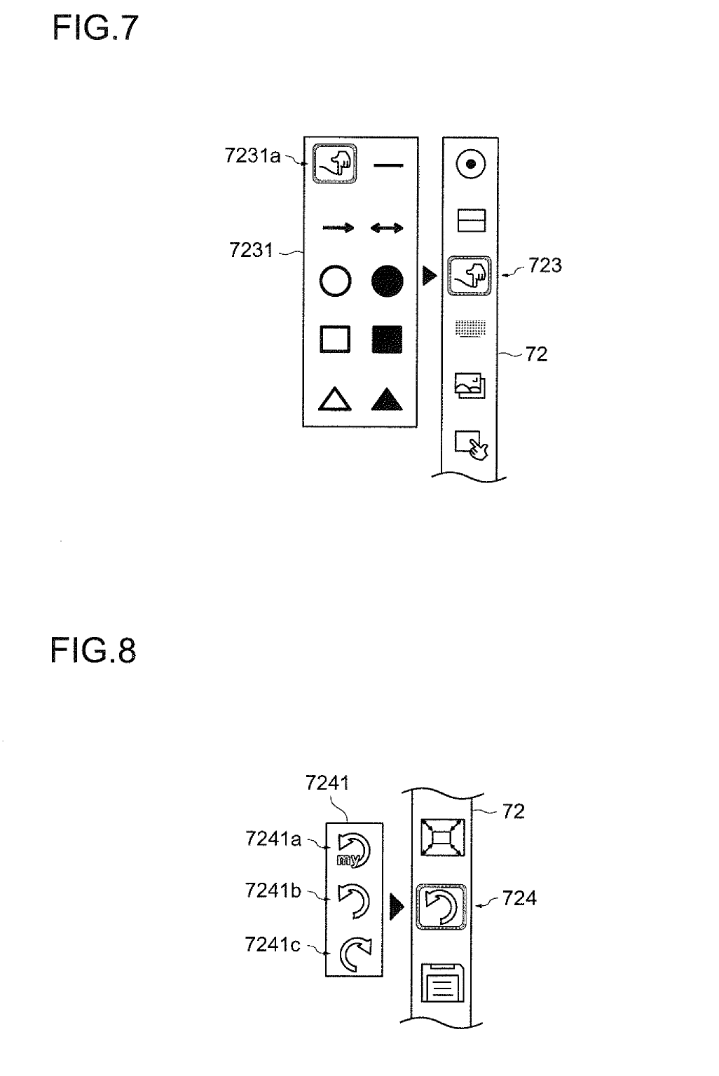

The drawing tool button 723 is an icon for adding a geometry in the drawing space. When the drawing tool button 723 is selected, near where it is displayed, a drawing palette 7231 is displayed. FIG. 7 is a diagram showing an example of how a drawing palette is displayed. As shown in FIG. 7, the drawing palette 7231 shows a plurality of geometry samples (straight line, arrow, circle, rectangle, triangle, etc.). When the user selects, for example, a free-hand icon 7231a through a touch operation, as he traces the surface of the touch panel 32, he can arrange a geometry corresponding to the trajectory of the touch operation in the drawing space. When the user selects one of the plurality of geometry samples through a touch operation, he can arrange the same geometry as the selected geometry sample in the drawing space. At this time, the user can also specify the size and other attributes of the geometry arranged; however, how to do that is out of the subject matter of the present invention, and therefore no further description will be given in that respect.

The undo button 724 is an icon for executing a reverse operation (undo) for cancelling a user operation that the user has executed in the drawing space, and for executing a re-performing operation (redo) for re-performing a so canceled user operation. When the undo button 724 is selected, near where it is displayed, an undo palette 7241 is displayed. FIG. 8 is a diagram showing an example of how an undo palette is displayed. As shown in FIG. 8, the undo palette 7241 shows a “my” undo button 7241a, a general undo button 7241b, and a redo button 7241c.

The “my” undo button 7241a is an icon for performing a personal undo process. A personal undo process denotes, for example with respect to client 3A, an operation for canceling the latest (most recent) one of the user operations that user A executed in the drawing space. In this case, a personal undo process can only cancel a user operation executed by user A.

The general undo button 7241b, by contrast, is an icon for performing a general undo process. A general undo process denotes an operation for canceling the latest (most recent) one of the user operations that any of all the users of the clients 3 executed in the drawing space. That is, for example, in the case of user A, a general undo process can cancel not only an operation entered by user A but also an operation entered by any user other than user A who is participating in the drawing space, and this applies to any user other than user A.

The redo button 7241c is an icon for performing a redo process for canceling a personal undo process or a general undo process.

The personal undo process, the general undo process, and the redo process mentioned above will be described in detail later.

The clear button 725 (see FIG. 4) is an icon for complete deletion of objects arranged in the drawing space.

### (Data Array Structure)

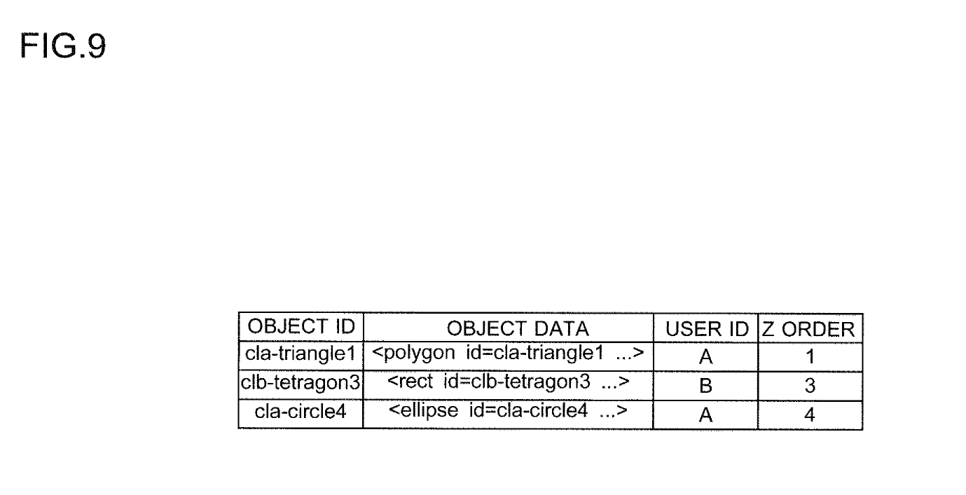

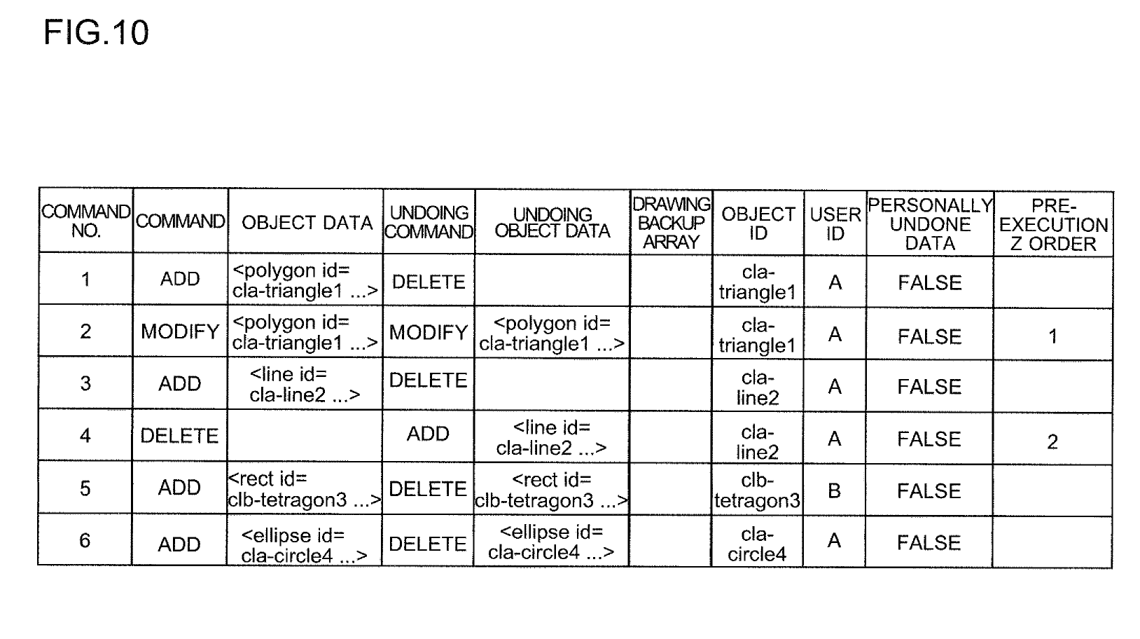

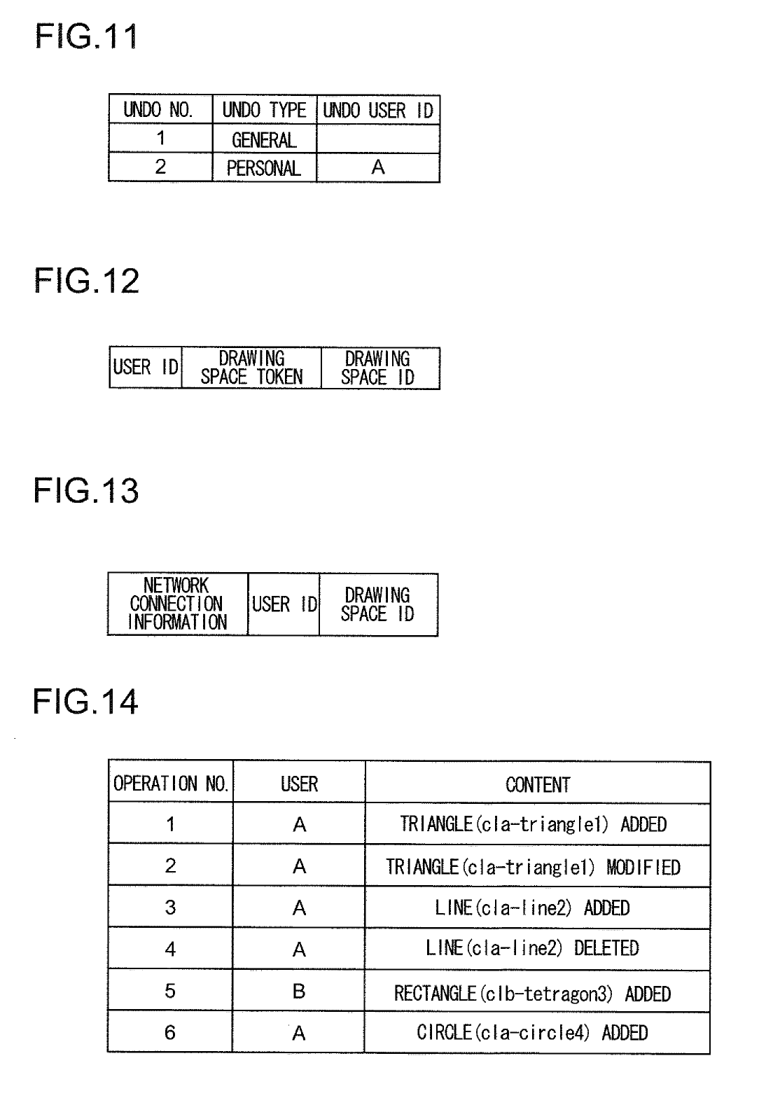

Next, a description will be given of each of the data arrays (drawing data array 51, overall operation history array 52, undo history array 53, drawing backup array 54, drawing space token array 55, and drawing space connection array 56; see FIG. 2) used in the drawing space. FIG. 9 is a data structure diagram showing an example of the drawing data array and the drawing backup array. FIG. 10 is a data structure diagram showing an example of the overall operation history array. FIG. 11 is a data structure diagram showing an example of the undo history array. FIG. 12 is a data structure diagram showing an example of the drawing space token array. FIG. 13 is a data structure diagram showing an example of the drawing space connection array. FIG. 14 is a table showing an example of user operations in the drawing space. The operations shown in FIG. 14 correspond to the data structures shown in FIGS. 9 and 10.

The drawing data array 51 shown in FIG. 9 is a drawing database for holding object data arranged in the drawing space. One such drawing data array exists for each drawing space. The drawing data array 51 includes object IDs, object data, user IDs, and Z orders. An object ID is data of a unique character string for identifying a particular set of object data arranged in the drawing space, and is an object identifier (object identification information) assigned to each set of object data. Object data is the main data of an object arranged in the drawing space. As will be described later, object data includes, among others, an object ID and vector data indicating detailed attributes of the object (for example, coordinates indicating a shape, stroke color, stroke width, and stroke type). A user ID is a uniform user identifier (user identifying information) for identifying the user using a client 3, and, in the drawing data array 51, indicates the user who arranged objects. A Z order is data representing hierarchical (layer depth) relationships among different objects in the drawing space. The greater the value of a Z order, the closer to the foreground (the topmost layer) an object is arranged; the smaller the value of a Z order, the closer to the background (the bottommost layer) an object is arranged. For example, an object with a Z order “1” is arranged in the background (the bottommost layer) in the drawing space.

The drawing backup array 54 is duplicated (backup) data of the drawing data array 51, and is generated when all the object data in the drawing space is deleted. That is, the drawing backup array 54 is a data array for restoring, through an undo process, which will be described later, the drawing space that has undergone a complete deletion operation. Accordingly, as shown in FIG. 9, the drawing backup array 54 has a data structure similar to that of the drawing data array 51. Moreover, the drawing backup array 54 is generated each time a complete deletion operation is performed on geometries, and is therefore tagged with a generation number (indicating the chronological order of its generation). For example, generation may be expressed in the form of the file name of the drawing backup array 54, or by meta data attached to the drawing backup array 54.

The overall operation history array 52 shown in FIG. 10 is a data array that functions as an operation history database in which are accumulated the records of individual user operations executed on the object data in the drawing space. The overall operation history array 52 is used to realize undo and redo processes on object data, and one such overall operation history array 52 exists for each drawing space. The overall operation history array 52 includes command numbers, commands, object data after user operations, undoing commands, undoing object data, generation-tagged drawing backup arrays 54, object IDs, users' user IDs, personally undone data, and pre-execution Z orders. In the overall operation history array 52 shown in FIG. 10, a blank cell denotes where no data is registered, or where null data is stored.

A command number is data for identifying the order in which the drawing server 2 received a command (the order in which the user operation indicated by the command was executed). A command denotes a user operation that the drawing server 2 received from the client 3 that the user uses. An undoing command is a reverse command indicating an undo operation (reverse operation) for canceling a user operation. Undoing object data indicates object data before a user operation. A drawing backup array 54 is registered, when a command indicates complete deletion of objects arranged in the drawing space, in a record that contains the command, and indicates where the drawing backup array 54 is stored and its generation number (#n, where n is a positive integer of 1 or more). An object ID is a unique object identifier for identifying object data. A user ID is a unique user identifier indicating a user who executed a user operation on object data. Personally undone data indicates whether or not a personal undo process, which will be described later, was performed. For a record that has not undergone a personal undo process, “FALSE” is set; for a record that has undergone a personal undo process, “TRUE” is set. A pre-execution Z order indicates the Z order of a record before execution of a user operation indicated by a command.

The undo history array 53 shown in FIG. 11 is a data array that functions as an undo history database in which are accumulated the records of individual undo operations that were executed with commands for cancelling user operations. One such undo history array exists for each drawing space. The undo history array 53 includes undo numbers, undo types, and undo user IDs. An undo number is data for identifying the order in which the drawing server 2 received a command for canceling a user operation (the order in which an undo operation was executed). An undo type indicates whether, as an undo operation, a personal undo process or a general undo process was executed. An undo user ID indicates the user ID of a user who executed personal undoing. Incidentally, when general undoing is executed, no data is registered, or null data is stored.

The drawing space token array 55 shown in FIG. 12 is a data array for associating a user who previously registered participation in a drawing space administered by the drawing server 2 with the drawing space in which the user is participating. The drawing space token array 55 includes a user ID, a drawing space token, and a drawing space ID. A drawing space ID) is unique data for identifying a drawing space administered by the drawing server 2, and, in the drawing space token array 55, indicates a drawing space in which a user identified by the user ID is permitted to participate. A drawing space token is data for associating a user with a drawing space ID, and is, for example, a temporary password for identifying the drawing space in which the user requests participation.

The drawing space connection array 56 shown in FIG. 13 is a data array for associating with one another a communication path of a client 3 that a user uses, the user, and a drawing space in which the user participates. The drawing space connection array 56 includes network connection information, a user ID, and a drawing space ID. Network connection information is acquired when a user newly connects to the drawing server 2 by use of WebSocket, SPDY, or any other similar protocol or the like. Network connection information contains, for example, an IP address of a transmission source (the client 3 that a user uses), a port, internal information on the drawing server 2 (for example, OS (operating system) parameters). A user ID indicates a user who is connected to the drawing server 2. A drawing space ID indicates a drawing space in which a user identified by a user ID participates (that is, a drawing space to which the client 3 that the user uses is admitted).

### (Object Data)

Next, object data arranged in a drawing space will be described in detail. As mentioned previously, geometry objects, text objects, image objects, etc. can be arranged in a drawing space. Geometric objects include, for example, objects such as free-hand (hand-drawn) geometries, straight lines, arrows, circles, rectangles, and triangles. FIGS. 15A to 15F show examples of expressions of different kinds of object data.

FIG. 15A is a diagram showing an example of data in which a free-hand geometric object is expressed. As shown in FIG. 15A, free-hand geometric object data contains, for example, an object ID, a color with which the region closed by the trajectory of a touch operation is filled, stroke width, stroke color, an array of coordinates across which the trajectory of the touch operation ran.

FIG. 15B is a diagram showing an example of data in which a straight line object is expressed. As shown in FIG. 15B, straight line object data contains, for example, an object ID, the X and Y coordinates at which a touch operation was started, the X and Y coordinates at which the touch operation was ended, stroke width, and stroke color.

FIG. 15C is a diagram showing an example of data in which a circle object is expressed. As shown in FIG. 15C, circle object data contains, for example, an object ID, the X and Y coordinates of the center, the radius in the X-axis direction, the radius in the Y-axis direction, stroke width, stroke color, and stroke type (for example, solid, broken, etc.).

FIG. 15D is a diagram showing an example of data in which a rectangle object is expressed. As shown in FIG. 15D, rectangle object data contains, for example, an object ID, the X and Y coordinates of a particular vertex, the size of the rectangle (width and height), stroke width, stroke color, and stroke type. The particular vertex is, for example, the upper left vertex when displayed on the touch panel 32.

FIG. 15 SE is a diagram showing an example of data in which a triangle object is expressed. As shown in FIG. 15E, triangle object data contains, for example, an object ID, the color with which the region surrounded by the three sides is filled, stroke width, stroke color, and an array of the coordinates of the three vertices.

FIG. 15F is a diagram showing an example of data in which a text object is expressed. As shown in FIG. 15F, text object data contains, for example, an object ID, the X and Y coordinates of a predetermined position of the region where text data is displayed, font size, character color, and a character string representing the contents of the text data. The predetermined position of the region where the text data is displayed is, for example, the top left corner of the region when displayed on the touch panel 32.

### (Admission to a Drawing Space)

Next, a description will be given of how user A participates in a drawing space and handles an object in the drawing space. In the following description, an example is taken where the client 3 that user A uses is admitted to a drawing space. Needless to say, admission of a client 3 other than client 3A is handled in a similar way. In the following description, the client 3 that user A uses is referred to as client 3A, and m clients (where m is zero or a positive integer of 1 or more) other than client 3A are collectively referred to as client 38.

### ((Log-in Authentication Process))

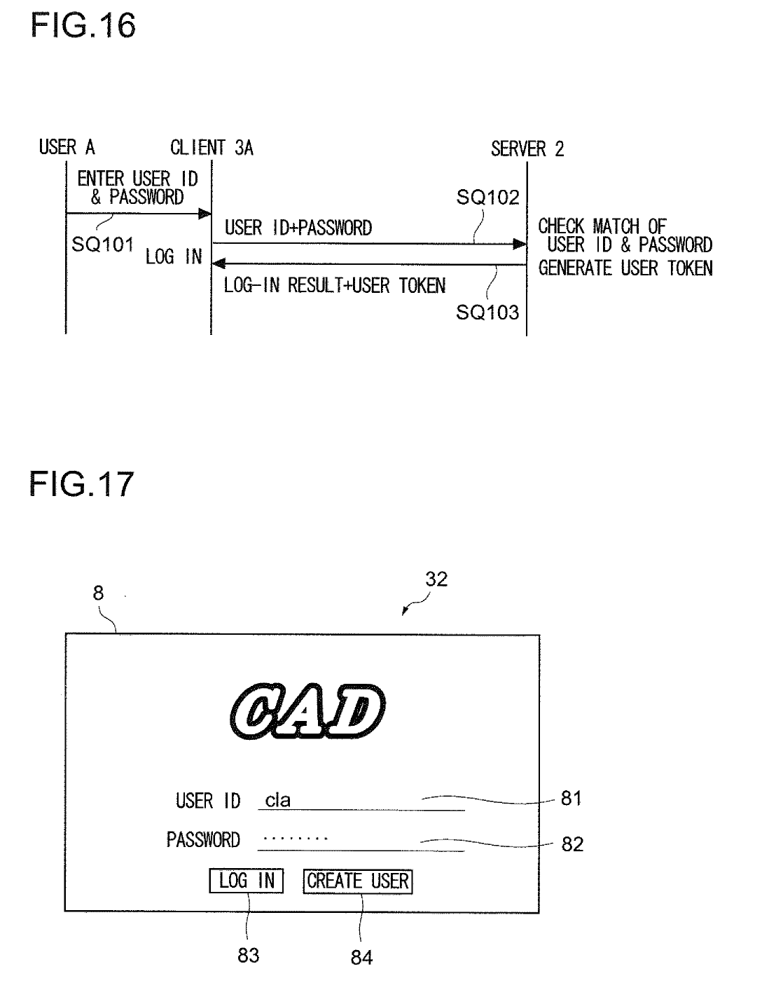

First, a description will be given of a log-in authentication procedure through which user A, by using client 3A, participates in a predetermined drawing space administered by the drawing server 2. FIG. 16 is a sequence diagram of user log-in authentication. FIG. 17 is a diagram showing an example of a log-in screen on a client.

When log-in authentication is started, a log-in screen 8 like the one shown in FIG. 17 is displayed on the touch panel 32 of client 3A. On the log-in screen 8, there are displayed a user ID text box 81, a password text box 82, a log-in button 83, and a create-user button 84. The user ID text box 81 is a display object for entry of a user ID, and the password text box 82 is a display object for entry of a password. The log-in button 83 is a display object for starting log-in authentication, and the create-user button 84 is a display object for registration of a new user on the drawing server 2.

Viewing the log-in screen 8, user A of client 3A enters, in the user ID text box 81, a unique user ID which is previously assigned to user A, and enters, in the password text box 82, the password of user A which is previously registered on the drawing server 2 (SQ101). When the user taps the log-in button 83, client 3A transmits the user ID and the password to the drawing server 2 by using the HTTP (or IHTTPS) protocol (SQ102).

The drawing server 2 checks whether or not the combination of the user ID and the password sent from client 3A is correct. If the combination of the user ID and the password is correct, the drawing server 2 generates a unique user token for client 3A. A user token is data for associating a user with a drawing space, and is, for example, a temporary password for identifying a user who requests participation. The drawing server 2 transmits, along with an indication that log-in authentication has been successful, the user token to client 3A (SQ103). Then, a drawing space admission process, which will be described below, is started.

Incidentally, if the combination of the user ID and the password is not correct, then at SQ103, the drawing server 2 transmits an error code indicating failure of log-in authentication to client 3A. The log-in authentication then ends. Instead, log-in authentication may be restarted from the beginning.

### ((Drawing Space Admission Process))

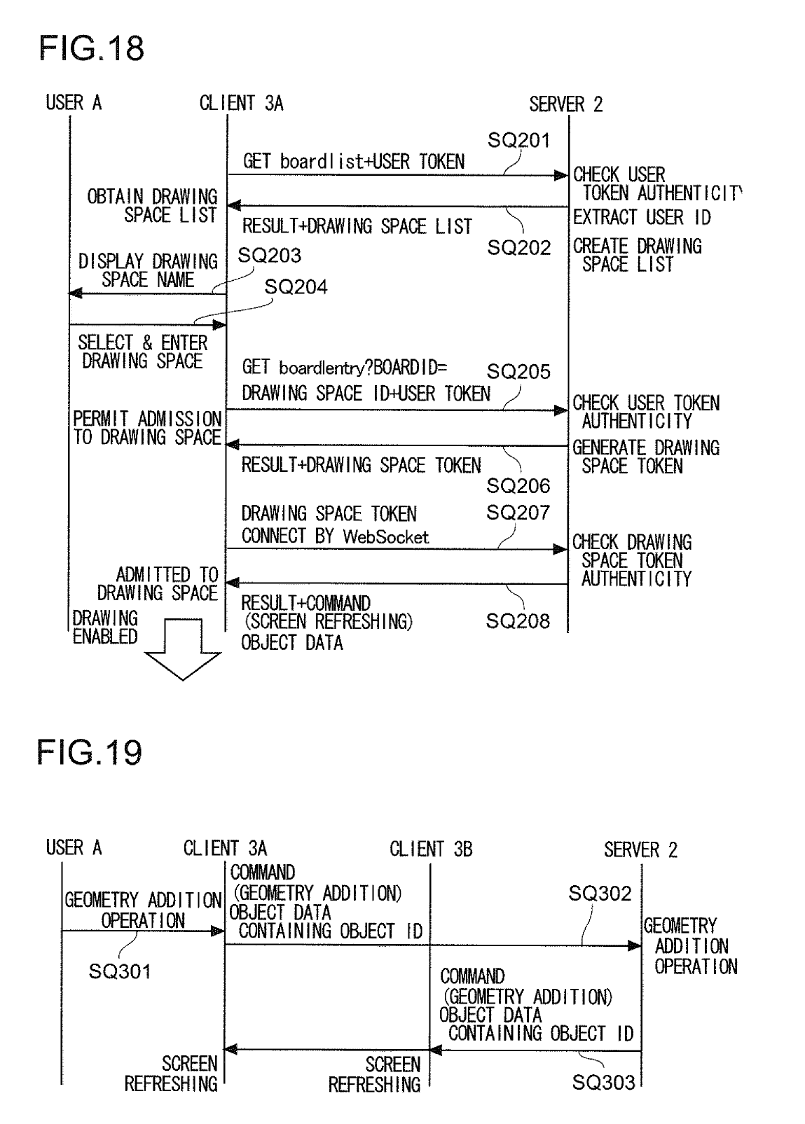

Next, a description will be given of a procedure whereby client 3A which the long-in authenticated user A uses is admitted to a drawing space. FIG. 18 is a sequence diagram of client admission.

Having been successfully log-in authenticated, client 3A transmits, along with the user token, an indication requesting a drawing space list (board list) indicating the drawing spaces in which user A can participate, to the drawing server 2 (SQ201).

The drawing server 2 checks whether or not the received user token is correct. If the user token is correct, the drawing server 2 extracts a user ID from the user token. Referring to the drawing space token array 55, the drawing server 2 identifies user A based on the user ID, and creates a drawing space list in which user A participates. Then, the drawing server 2 transmits, along with an indication of permission to provide the drawing space list, the drawing space list to client 3A (SQ202).

If the user token is not correct, then at SQ202, the drawing server 2 transmits to client 3A an indication of refusal to provide a drawing space list.

Having received the drawing space list, client 3A displays the drawing space list (for example, a list of the names of individual drawing spaces) on the touch panel 32 (SQ203). Viewing the drawing space list, user A selects, through a tap operation, a drawing space in which he wants to participate (SQ204). Client 3A transmits, along with the drawing space ID of the selected drawing space, an indication of request for permission of admission and the user token to the drawing server 2 (SQ205).

The drawing server 2 checks whether or not the received user token is correct. If the user token is correct, the drawing server 2 generates a drawing space token corresponding to the received drawing space ID. At this time, the drawing server 2 registers the user ID, the generated drawing space token, and the received drawing space ID in the drawing space token array 55. Then, the drawing server 2 transmits, along with an indication of permission of admission, the drawing space token to client 3A (SQ206).

On the other hand, if the user token is not correct, then at SQ206, the drawing server 2 transmits an indication of refusal of admission to client 3A.

When permitted admission, client 3A, along with the drawing space token, connects to the drawing server 2, for example, by WebSocket (SQ207).

On detecting a new connection by WebSocket, the drawing server 2 checks whether or not a drawing space token is added. If a drawing space token is added, the drawing server 2 refers to the drawing space token array 55, and checks whether or not the received drawing space token matches the drawing space token that was transmitted to client 3A (that is, user A) at SQ206.

If the drawing space token is correct, the drawing server 2 additionally registers in the drawing space connection array 56 the network connection information acquired when newly connecting by WebSocket, the user ID, and the drawing space token. Moreover, the drawing server 2 edits the drawing data array 51 of the drawing space to which client 3A has been admitted. Incidentally, through the editing here, the records in the drawing data array 51 are rearranged in the order of their Z orders. Then, the drawing server 2 transmits, along with an indication of permission of connection (the result of the drawing space admission process) and a command indicating screen refreshing, only the object data out of the edited drawing data array 51 to client 3A (SQ208). Based on the received object data, client 3A displays a drawing space on the liquid crystal display 321. In this way, user A can participate in a desired drawing space, and becomes ready to handle objects.

On the other hand, if, at SQ207, no drawing space token is added, or the added drawing space token is not correct, then at SQ208, the drawing server 2 refuses connection with client 3A.

### (Handling Objects)

Having participated in a drawing space, user A can perform operations such as addition, deletion, modification, complete deletion, etc. on objects. In the following description, as examples of such operations, different operations on geometric objects will be described.

### ((Adding (Arranging) an Object))

First, a description will be given of a process whereby user A adds a geometry in the drawing space. Through this process, a geometric object is arranged in the drawing space.

### (((System Operation)))

FIG. 19 is a sequence diagram of a geometry addition process. User A selects a desired geometry sample from the drawing palette 7231 (see FIG. 7) on the display screen 7 of client 3A and enters the geometry to be added in the drawing space (SQ301).

Client 3A simultaneously generates geometric object data based on user input and an object ID for it. For example, when a free-hand icon 7231a is selected from the drawing palette 7231, as user A traces the touch panel 32, a geometry corresponding to the trajectory is entered. Client 3A detects relevant coordinates of the geometry hand-drawn by the user, and generates object data (FIG. 15A) of a geometry that passes across those coordinates and a unique object ID of the geometric object data.

When a geometry sample icon indicating a straight line is selected, client 3A generates object data of a straight line (FIG. 15B) and an object ID of the geometric object data. The geometric object data indicates a straight line that connects between first coordinates indicating the position where user A started a touch operation and second coordinates indicating the position where he ended the touch operation. The first coordinates are those of the position where a finger of a touch pen first touched the touch panel 32, and the second coordinates are those of the position where the finger or the touch pen left the touch panel 32.

When a geometry sample icon indicating a circle is selected, client 3A generates object data of a circle (FIG. 15C) and an object ID of the geometric object data. The geometric object data here indicates a circle that is inscribed in a rectangle having as a diagonal line thereof the line connecting between first coordinates indicating the position where user A started a touch operation and second coordinates indicating the position where he ended the touch operation, the circle having its center at the center of the diagonal line.

When a geometry sample icon indicating a rectangle is selected, client 3A generates object data of a rectangle (FIG. 15D) and an object ID of the geometric object data. The geometric object data here indicates a rectangle that is inscribed in a rectangle having as a diagonal line thereof the line connecting between first coordinates indicating the position where user A started a touch operation and second coordinates indicating the position where he ended the touch operation.

When a geometry sample icon indicating a triangular is selected, client 3A simultaneously generates object data of a triangle (FIG. 15E) and an object ID of the geometric object data. The geometric object data here indicates a triangle that is inscribed a rectangle having as a diagonal line thereof the line connecting between first coordinates indicating the position where user A started a touch operation and second coordinates indicating the position where he ended the touch operation.

Then, client 3A transmits, along with a command indicating geometry addition, the object data containing the object ID to the drawing server 2 (SQ302).

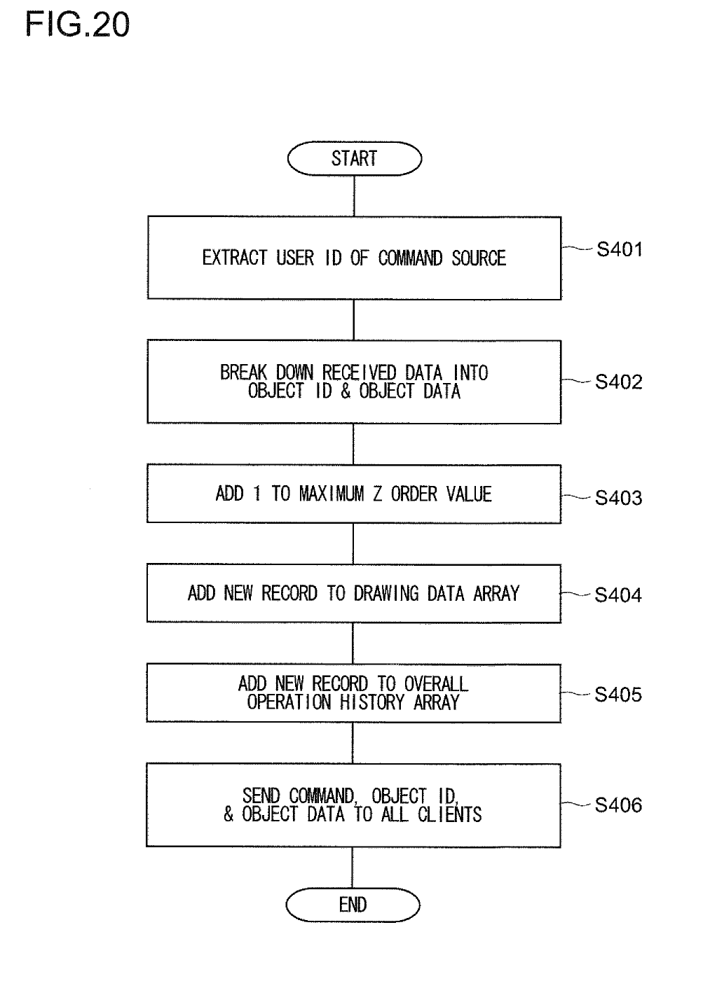

On receiving the command indicating geometry addition from client 3A, the drawing server 2 performs a geometry addition process (see FIG. 20, which will be described later). Then, the drawing server 2 transmits the command (geometry addition) and the object data containing the object ID to all the clients 3 that have been admitted to the drawing space (SQ303).

Client 3A (and client B) receives the command (geometry addition) and the object data containing the object ID from the drawing server 2, and refreshes the display screen 7 to display the received object data. In this way, the geometry that user A entered is arranged in the drawing space.

### (((Drawing Server Operation)))

Now, the operation of the drawing server 2 in the geometry addition process will be described in detail. FIG. 20 is a flow chart showing the operation of the drawing server 2 in the geometry addition process.

Based on the network connection information acquired when the command for geometry addition was received, the drawing server 2 extracts from the drawing space connection array 56 the user ID which corresponds to the source of the command (S401). Moreover, the drawing server 2 breaks down the data received from client 3A into the object ID and the object data (S402). Moreover, the drawing server 2 detects the maximum Z order value from the overall operation history array 52, and prepares a value obtained by incrementing the maximum value by one (by adding 1 to it) (S403). Incidentally, this value indicates the foreground in the drawing space.

Using the data obtained at S402 and S403, the drawing server 2 edits the drawing data array 51 of the drawing space to which client 3A has been admitted (S404). Through the editing here, a new record including the object ID, the object data, the user ID indicating user A, and a Z order for arranging the geometry in the foreground is added to the drawing data array 51.

Simultaneously with S404, the drawing server 2, by using the data obtained at S402 and S403, edits the overall operation history array 52 of the drawing space to which client 3A has been admitted (S405). Through the editing here, a new record is added to the overall operation history array 52. The new record includes the most recent command number, the command (geometry addition), the object data, an undoing command (geometry deletion), the object ID, the user ID, and personally undone data. The command (geometry addition) is received from client 3A, and the undoing command (geometry deletion) is used to cancel the geometry addition operation. Moreover, the user ID indicates user A, and the personally undone data indicates “FALSE.” Here, the command received from client 3A indicates geometry addition, and accordingly the undoing command indicates geometry deletion. The new record does not include undoing object data, a drawing backup array, or a pre-execution Z order; the new record may instead include null data for them.

Then, the drawing server 2 performs SQ303 described previously (S406). At this time, any data for which null (object) data is stored may or may not be transmitted.

Incidentally, although in the above described example of addition, a geometric object is added, any other object (for example, a text object, an image object, etc.) can instead be added through a similar procedure.

### ((Modifying an Object))

Next, a description will be given of a process whereby user A modifies a geometry in the drawing space. Here, as an example of a geometry modification process, how the color of the strokes of a geometry already arranged in the drawing space is changed will be described.

### (((System Operation)))

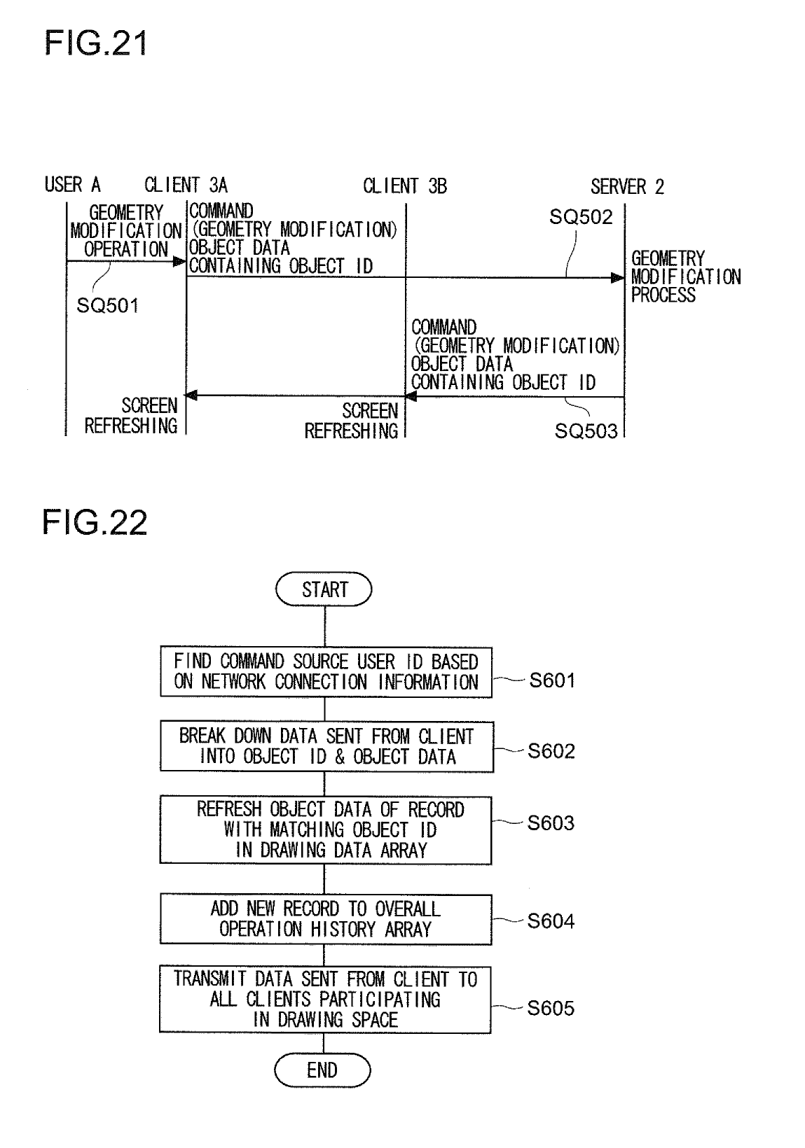

FIG. 21 is a sequence diagram of a geometry modification process. User A selects a geometry to be modified from the drawing space, and then selects a desired stroke color sample from the stroke color selection palette 7211 (see FIG. 5) on the display screen 7 of client 3A (SQ501).

Client 3A generates modified geometric object data and finds the object ii) of the selected geometry. Then, client 3A transmits, along with a command for geometry modification, the modified object data containing the object ID to the drawing server 2 (SQ502).

On receiving the command indicating geometry modification from client 3A, the drawing server 2 performs a geometry modification process (see FIG. 22, which will be described later). Then, the drawing server 2 transmits the command (geometry modification) and the modified object data containing the object ID to all the clients that have been admitted to the drawing space (SQ503).

Client 3A (and client 3B) receives the command (geometry modification) and the modified object data containing the object ID from the drawing server 2, and refreshes the display screen 7 to display the received object data. In this way, the geometry modified by user A is arranged in the drawing space.

### (((Drawing Server Operation)))

Now, the operation of the drawing server 2 in the geometry modification process will be described in detail. FIG. 22 is a flow chart showing the operation of the drawing server 2 in the geometry modification process.

Based on the network connection information acquired when the command for geometry modification was received, the drawing server 2 extracts from the drawing space connection array 56 the user ID which corresponds to the source of the command (S601). Moreover, the drawing server 2 breaks down the data received from client 3A into the object ID and the object data (S602).

Using the data obtained at S602, the drawing server 2 edits the drawing data array 51 of the drawing space to which client 3A has been admitted (S603). Through the editing here, in the drawing data array 51, only the object data corresponding to the object ID received at SQ502 is replaced with the received object data.

Simultaneously with S603, the drawing server 2, by using the data obtained at S602, edits the overall operation history array 52 of the drawing space to which client 3A has been admitted (S604). Through the editing here, a new record is added to the overall operation history array 52. The new record includes the most recent command number, the command (geometry modification), the object data, an undoing command (geometry modification), undoing object data, the object ID), the user ID, personally undone data, and a pre-execution Z order. The command (geometry modification) is transmitted from client 3A, and the undoing command (geometry modification) is used to cancel the geometry modification operation. The undoing object data is the object data before the geometry modification process, and the user ID indicates user A. The personally undone data indicates “FALSE,” and the pre-execution Z order indicates the Z order before the geometry modification process. Since the command received from client 3A indicates geometry modification, the undoing command also indicates geometry modification. The new record does not include a drawing backup array; it may instead contain null data for it.

Then, the drawing server 2 performs SQ503 described previously (S605). At this time, any data for which null (object) data is stored may or may not be transmitted.

Although in the example described above, the color of the strokes of a geometry is modified, any other attribute (for example, stroke width, filled or not, etc.) can instead be modified through a similar procedure.

### ((Deleting an Object))

Next, a description will be given of a process whereby user A deletes a geometry in the drawing space. Through this process, a geometry object already arranged in the drawing space is selectively deleted.

### (((System Operation)))

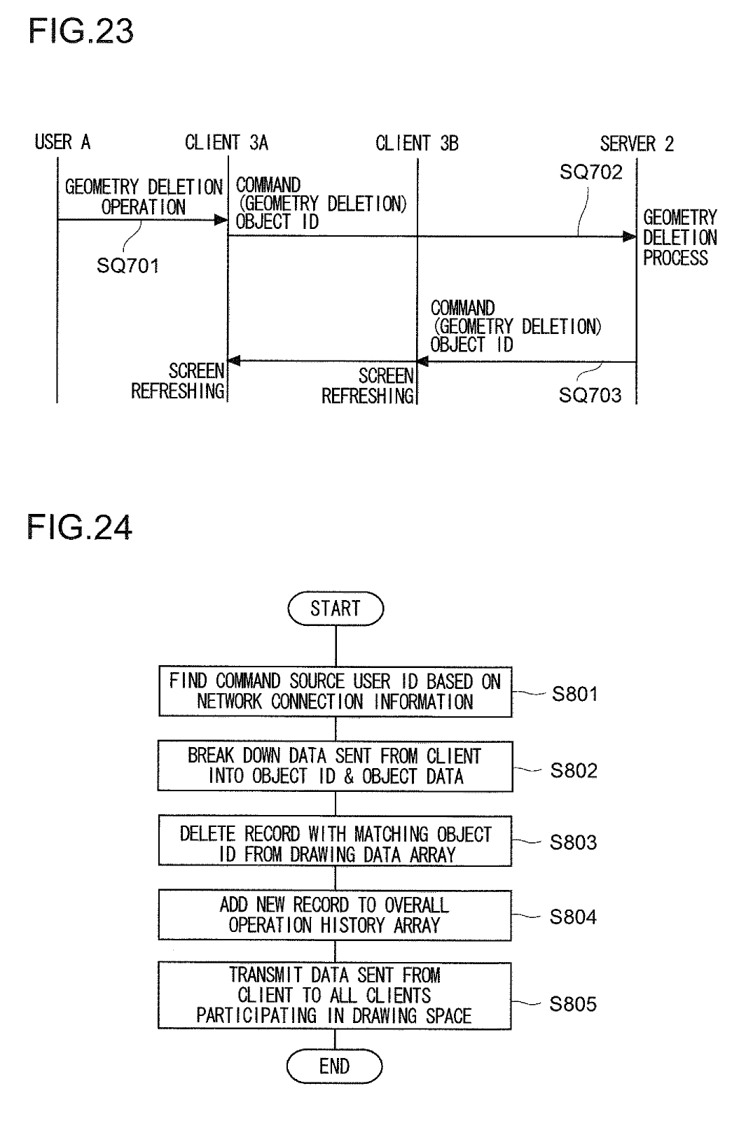

FIG. 23 is a sequence diagram of a geometry deletion process. User A selects from the drawing space a geometry to be deleted, and then selects the clear button 725 (see FIG. 4) on the display screen 7 of client 3A (SQ701).

Client 3A transmits, along with a command indicating geometry deletion, the object ID of the selected geometry to the drawing server 2 (SQ702).

On receiving the command indicating geometry deletion from client 3A, the drawing server 2 performs geometry deletion process (see FIG. 24, which will be described later). Then, the drawing server 2 transmits the command (geometry deletion) and the object ID to all the clients 3 that have been admitted to the drawing space (SQ703).

Client 3A (and client 3B) receives the command (geometry deletion) and the object ID from the drawing server 2, and deletes the geometry having the received object ID from the drawing space. In this way, the geometry deleted by user A is erased from the drawing space.

### (((Drawing Server Operation)))

Now, the operation of the drawing server 2 in the geometry deletion process will be described in detail. FIG. 24 is a flow chart showing the operation of the drawing server 2 in the geometry deletion process.

Based on the network connection information obtained when the command indicating geometry deletion was received at SQ702, the drawing server 2 extracts from the drawing space connection array 56 the user ID which corresponds to the source of the command (S801). Moreover, the drawing server 2 breaks down the data received from client 3A into the object ID and the object data (S802).

Using the data obtained at S802, the drawing server 2 edits the drawing data array 51 of the drawing space to which client 3A has been admitted (S803). Through the editing here, from the drawing data array 51, the record (comprising an object ID, object data, a user ID, and a Z order) containing the object ID obtained at S802 is deleted.

Simultaneously with S803, the drawing server 2, by using the data obtained at S802, edits the overall operation history array 52 of the drawing space to which client 3A has been admitted (S804). Through the editing here, a new record is added to the overall operation history array 52. This record includes the most recent command number, the command (geometry deletion), an undoing command (geometry addition), undoing object data, the object ID, the user ID, personally undone data, and the pre-execution Z order. The command (geometry deletion) is received from client 3A, and the undoing command (geometry addition) is used to cancel the geometry deletion operation. The undoing object data is the object before the geometry deletion process, and the user ID indicates user A. The personally undone data indicates “FALSE,” and the pre-execution Z order indicates the Z order before the geometry deletion process. Since the command received from client 3A indicates geometry deletion, the undoing command indicates geometry addition. The new record does not include object data or a drawing backup array; instead, null (object) data may be stored for them.

Then, the drawing server 2 performs SQ703 described previously (S805). At this time, any data for which null (object) data is stored may or may not be transmitted.

Although in the example described above, a geometry is deleted, any other object (for example, a text object, an image object, or the like) can instead be deleted through a similar procedure.

### ((Complete Deletion of Objects))

Next, a description will be given of a process whereby user A deletes everything in the drawing space. Through this process, all the objects already arranged in the drawing space are deleted.

### (((System Operation)))

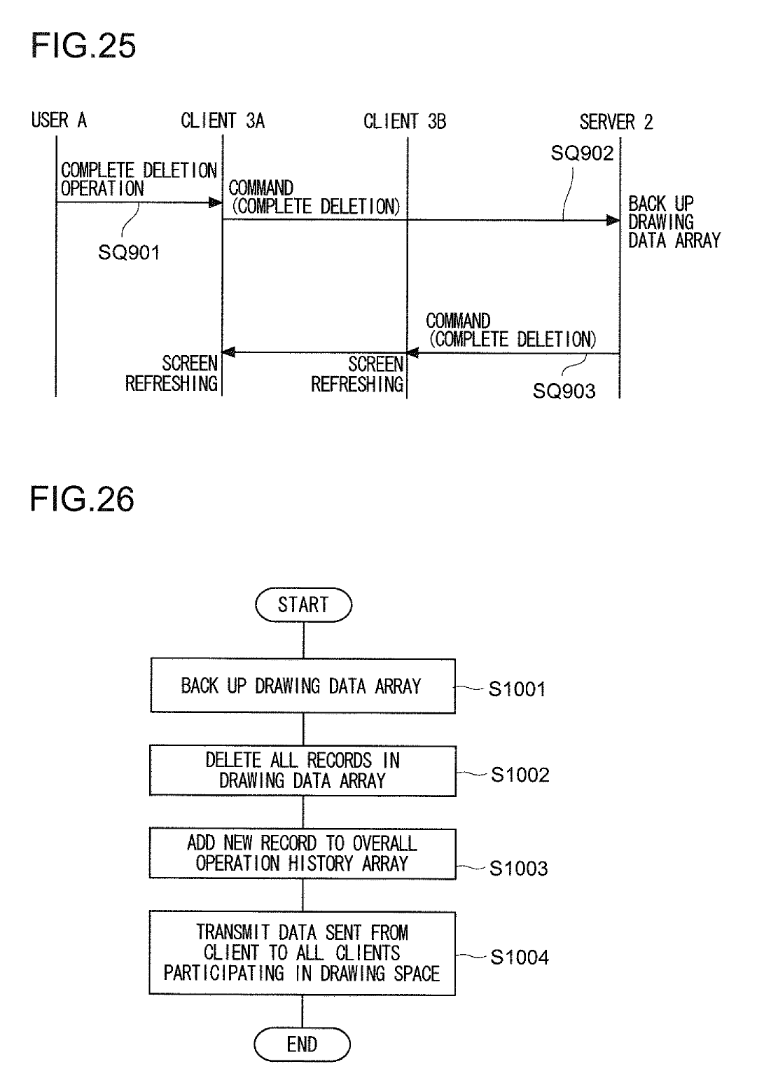

FIG. 25 is a sequence diagram of a complete deletion process. With no geometry in the drawing space selected, user A selects the clear button 725 (see FIG. 4) on the display screen 7 of client 3A (SQ901).

Client 3A transmits a command indicating complete deletion to the drawing server 2 (SQ902).

On receiving the command indicating complete deletion, the drawing server 2 performs a complete deletion process (see FIG. 26, which will be described later). Then, the drawing server 2 transmits the command (complete deletion) to all the clients that have been admitted to the drawing space.

On receiving the command (complete deletion) from the drawing server 2, client 3A (and client 31) erases all the geometries displayed on the liquid crystal display 321. In this way, all the objects arranged in the drawing space are deleted.

### (((Drawing Server Operation)))

Now, the operation of the drawing server 2 in the complete deletion process will be described in detail. FIG. 26 is a flow chart showing the operation of the drawing server 2 in the complete deletion process.

By making a backup copy of (duplicating) the drawing data array 51, the drawing server 2 generates a drawing backup array 54 (S1001). Then, the drawing server 2 edits the drawing data array 51 of the drawing space to which client 3A has been admitted (S1002). Through the editing here, all the records (comprising object IDs, object data, user IDs, and Z orders) registered in the drawing data array 51 of the drawing space to which client 3A has been admitted are deleted.

Simultaneously with S1002, the drawing server 2 edits the overall operation history array 52 of the drawing space to which client 3A has been admitted (S1003). Through the editing here, again, a new record is added to the overall operation history array 52. This record includes the most recent command number, the command (complete deletion), an undoing command (restoration), the drawing backup array 54 along with its generation number, the user ID, and personally undone data. The command (complete deletion) is transmitted from client 3A, and the undoing command (restoration) is used to cancel the complete deletion operation. The user ID indicates user A, and the personally undone data indicates “FALSE.” Since the command received from client 3A indicates complete deletion, the undoing command indicates restoration. The new record does not include object data, undoing object data, an object ID, or a pre-execution Z order; null (object) data may instead be stored for each of them.

Then, the drawing server 2 performs SQ903 described previously (S1004). At this time, any data for which null (object) data is stored may or may not be transmitted.

### (Process for Setting an Undoing Command and Undoing Object Data)

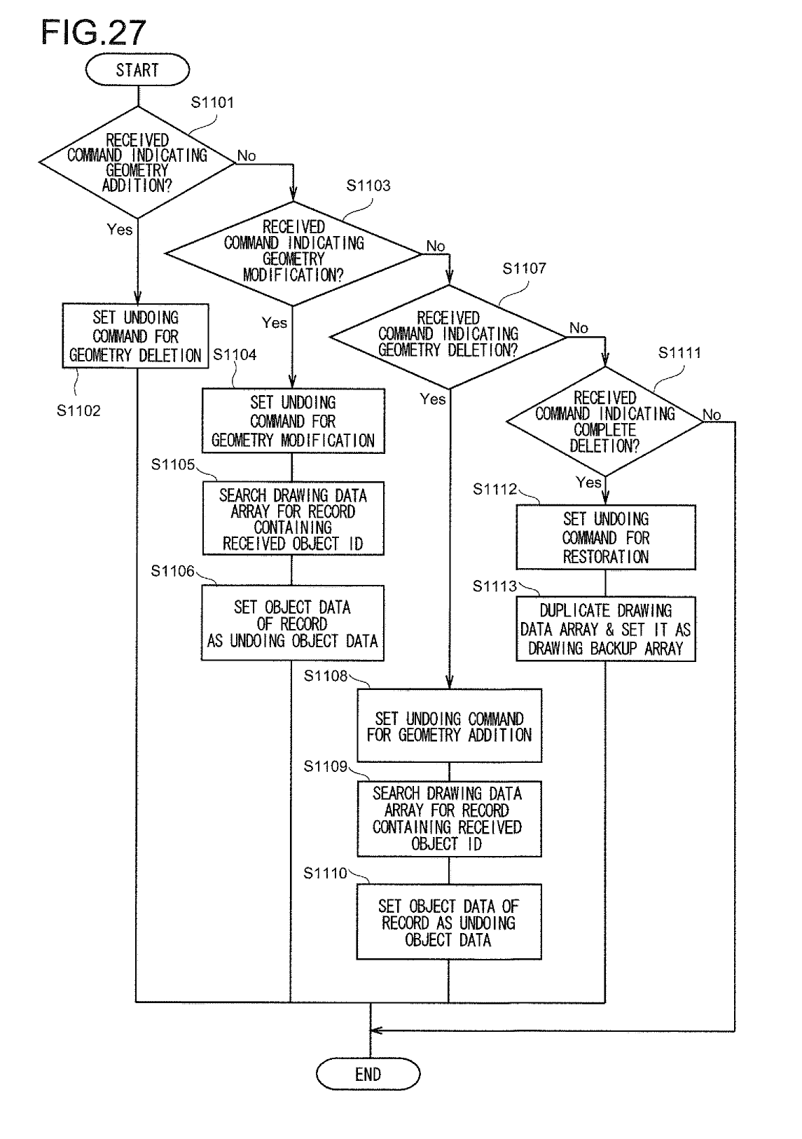

Next, a description will be given of a method for determining data related to undoing of a record added to the overall operation history array 52. FIG. 27 is a flow chart showing a method of setting an undoing command and undoing object data. The following description deals with an example where, from client 3A which user A uses, a command corresponding to a user operation to be executed on a geometric object has been received.

On receiving the command from client 3A, the drawing server 2 checks whether the command indicates geometry addition, geometry modification, geometry deletion, or complete deletion of objects.

First, whether or not the received command indicates geometry addition is checked (S1101). If it is found to indicate geometry addition (S1101, “Yes”), then for cancellation of geometry addition, an undoing command indicating geometry deletion is generated (S1102). Then, the process is ended.

If the received command is found not to indicate geometry addition (S1101, “No”), then whether or not it indicates geometry modification is checked (S1103). If it is found to indicate geometry modification (S1103, “Yes”), then for cancellation of geometry modification, an undoing command indicating geometry modification is generated (S1104). Moreover, the drawing data array 51 is searched for records containing the received object ID (S1105). Then, the object data of the drawing data array 51 that has been obtained as a result of the search is set as undoing object data for the overall operation history array 52 (St 106). Then, the process is ended.

If the received command is found not to indicate geometry modification (S1103, “No”), then whether or not it indicates geometry deletion is checked (S1107). If it is found to indicate geometry deletion (S1107, “Yes”), then for cancellation of geometry deletion, an undoing command indicating geometry addition is generated (S1108). Also, the drawing data array 51 is searched for records containing the received object ID (S1109). Then, the object data of the drawing data array 51 that has been obtained as a result of the search is set as undoing object data for the overall operation history array 52 (S1110). Then, the process is ended.

If the received command is found not to indicate geometry deletion (S1107, “No”), then whether or not it indicates complete deletion is checked (S1111). If it is found to indicate complete deletion (S1111, “Yes”), then for cancellation of the complete deletion operation, an undoing command indicating restoration is generated (S1112). Moreover, the drawing data array 51 is duplicated to generate a drawing backup array 54 of the nth generation (where n is a positive integer of 1 or more), which is then stored in the storage 21 in association with the drawing space (S1113). The generation number assigned to the drawing backup array 54 indicates its serial place among the drawing backup arrays 54 with which the drawing space is associated. Then, the process is ended.

If the received command is found not to indicate complete deletion (S1111, “No”), then, the process is ended without setting any undoing command or undoing object data.

### (Undo Process)

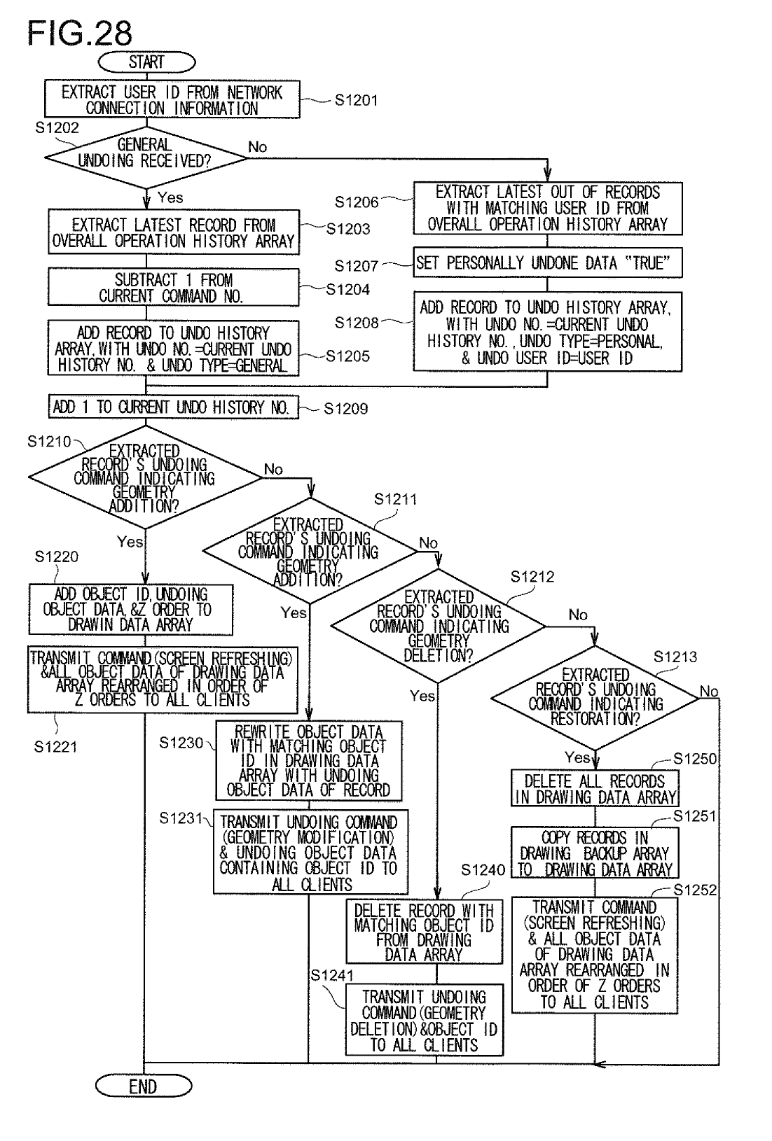

A user of any client 3 can execute an undo operations to cancel a user operation performed in a drawing space as described above. FIG. 28 is a flow chart of an undo process on the drawing server. Now, with reference to FIG. 28, the undo process will be described.

To cancel the latest operation performed, user A selects the undo button 724 on the display screen 7 of client 3A, Moreover, user A selects and enters the “my” undo button 7241a or the general undo button 7241b from the undo palette 7241 (see FIG. 8). According to the selection by user A, client 3A transmits a command indicating a personal undo process or a general undo process to the drawing server 2.

Based on the network connection information obtained when the command indicating a personal undo process or a general undo process was received, the drawing server 2 extracts from the drawing space connection array 56 the user ID which corresponds to the source of the command (undo) (S1201).

Moreover, the drawing server 2 checks whether the command (undo) received from client 3A is a personal undo process or a general undo process (S1202).

If it is found to be a command indicating a general undo process (S1202, “Yes”), then the drawing server 2 extracts the latest record from the overall operation history array 52 (S1203). That is, from the overall operation history array 52, out of the records whose command numbers are less than the current command number and whose personally undone data is “FALSE,” the record with the maximum command number is extracted. Moreover, the drawing server 2 subtracts 1 from the current command number (S1204). For example, in the case of the overall operation history array 52 shown in FIG. 10, if the command number at the time point of S1203 is “7,” then the record with a command number “6” is extracted, and the command number at the time point of S1204 is set to be “6.”

Then, a new record is added to the undo history array 53, the current undo history number is set as its undo number, and general undoing is set as its undo type (S1205). For example, in the case of the undo history array 53 shown in FIG. 11, if a command for canceling a user operation is executed in the drawing space for the first time after a predetermined time point (for example, the time that the drawing space was established, or a time point specified a the user), the undo number is set to be “1.” If the command indicates general undoing, the undo type is set to be “general undoing,” and no corresponding data, or instead null data, is registered in the undo user ID.

On the other hand, if the command is found to be a command indicating a personal undoing process (S1202. “No”), then the drawing server 2 extracts from the overall operation history array 52 the latest record out of the records having the relevant user ID (S1206). That is, out of the records whose command numbers are less than the current command number, whose user ID matches the user ID extracted at S1201, and whose personally undone data is “FALSE,” the record with the maximum command number is extracted. Moreover, the personally undone data of the extracted record is set to be “TRUE” (S1207). For example, in the case of the overall operation history array 52 shown in FIG. 10, if the command number at the time point of S1206 is “7,” then the record having a command number “6” is extracted, and then at S1207, the personally undone data of the record having a command number “6” is set to be “TRUE.” Incidentally, the command number at the time point of S1207 remains “7.”

Then, a new record is added to the undo history array 53, the current undo history number is set as its undo number, and general undoing is set as its undo type (S1208). For example, in the case of the undo history array 53 in FIG. 11, if a command for cancelling a user operation is performed for the second time in the drawing space, the undo number is set to be “2.” If the command indicates personal undoing, the undo type is set to be “personal undoing,” and the user ID of the user (for example, user A) who performed the user operation is set as the undo user ID.

Next, the drawing server 2 adds 1 to the current undo history number (S1209). Then, the drawing server 2 checks what type of geometry handling (geometry addition, geometry modification, geometry deletion, or restoration) is indicated by the undoing command of the record extracted at S1203 or S1206. First, the drawing server 2 checks whether or not the undoing command of the extracted record indicates geometry addition (S1210). If geometry addition is found to be indicated (S1210, “Yes”), then an advance is made to S1220, which will be described later, to perform a geometry addition operation through an undo process.

If no geometry addition is found to be indicated (S1210, “No”), then whether or not geometry modification is indicated is checked (S1211). If geometry modification is found to be indicated (S1211, “Yes”), then an advance is made to S1230, which will be described later, to perform a geometry modification operation through an undo process.

If no geometry modification is found to be indicated (S1211, “No”), then whether or not geometry deletion is indicated is checked (S1212). If geometry deletion is found to be indicated (S1212, “Yes”), then an advance is made to S1240, which will be described later, to perform a geometry deletion operation through an undo process.

If no geometry deletion is found to be indicated (S1212, “No”), then whether or not restoration is indicated is checked (S1213). If restoration is found to be indicated (S1213, “Yes”), an advance is made to S1250, which will be described later, to perform a restoration operation through an undo process. If no restoration is found to be indicated (S1213, “No”), then the process is ended.

### ((Undo, Geometry Addition))

In an undo process for a geometry addition operation, the drawing server 2 adds to the drawing data array 51 the object ID, the undoing object data, and the Z order of the record extracted from the overall operation history array 52 at S1203 or S1206 (S1220). That is, these pieces of data are registered as the object ID, the object data, and the Z order of the record added to the drawing data array 51. Incidentally, in the user ID of the added record, the user ID extracted at S1201 is registered.

Moreover, the drawing server 2 transmits a command (screen refreshing) and all the object data of the drawing data array 51 rearranged in the order of Z orders to all the clients 3 (S1221). Based on the received data, each client 3 refreshes the screen.

### ((Undo, Geometry Modification))

In an undo process for a geometry modification operation, the drawing server 2 replaces, with the undoing object data of the record extracted from the overall operation history array 52 at S1203 or S1206, the object data of the drawing data array 51 indicated by the object ID of the extracted record (S1230).

Moreover, the drawing server 2 transmits to all the clients 3 that have been admitted to the drawing space an undoing command (geometry modification) and the object ID) and the undoing object data of the record extracted at S1203 or S1206 (S1231). At this time, the pre-execution Z order may also be transmitted. Each client 3 receives the undoing command (geometry modification) and the undoing object data containing the object ID from the drawing server 2. Then, based on the received undoing object data, each client 3 refreshes the display screen 7.

### ((Undo, Geometry Deletion))

In an undo process for a geometry deletion operation, the drawing server 2 deletes from the drawing data array 51 the record containing the same object ID as that of the record extracted from the overall operation history array 52 at S1203 or S1206 (S1240).

Moreover, the drawing server 2 transmits to all the clients 3 that have been admitted to the drawing space an undoing command (geometry deletion) and the object ID of the record extracted at S1203 or S1206 (S1241). At this time, no undoing object data is transmitted; null data may instead be transmitted. Each client 3 receives the undoing command (geometry deletion) and the object ID from the drawing server 2, and erases the geometry corresponding to the received object ID from the display screen 7.

### ((Undo, Restoration))

In an undo process for a restoration operation, the drawing server 2 deletes all records from the drawing data array 51 (S1250). Thereafter, the drawing server 2 adds all the records of the drawing backup array 54 to the drawing data array 51 (S1251). Then, the drawing server 2 transmits to all the clients 3 that have been admitted to the drawing space a command (screen refreshing) and the object data of the records of the drawing data array 51 arranged in the order of Z orders (S1252).

Each client 3 receives the undoing command (screen refreshing) and the object data from the drawing server 2, and refreshes the screen based on the received object data.

### (Redo Process)

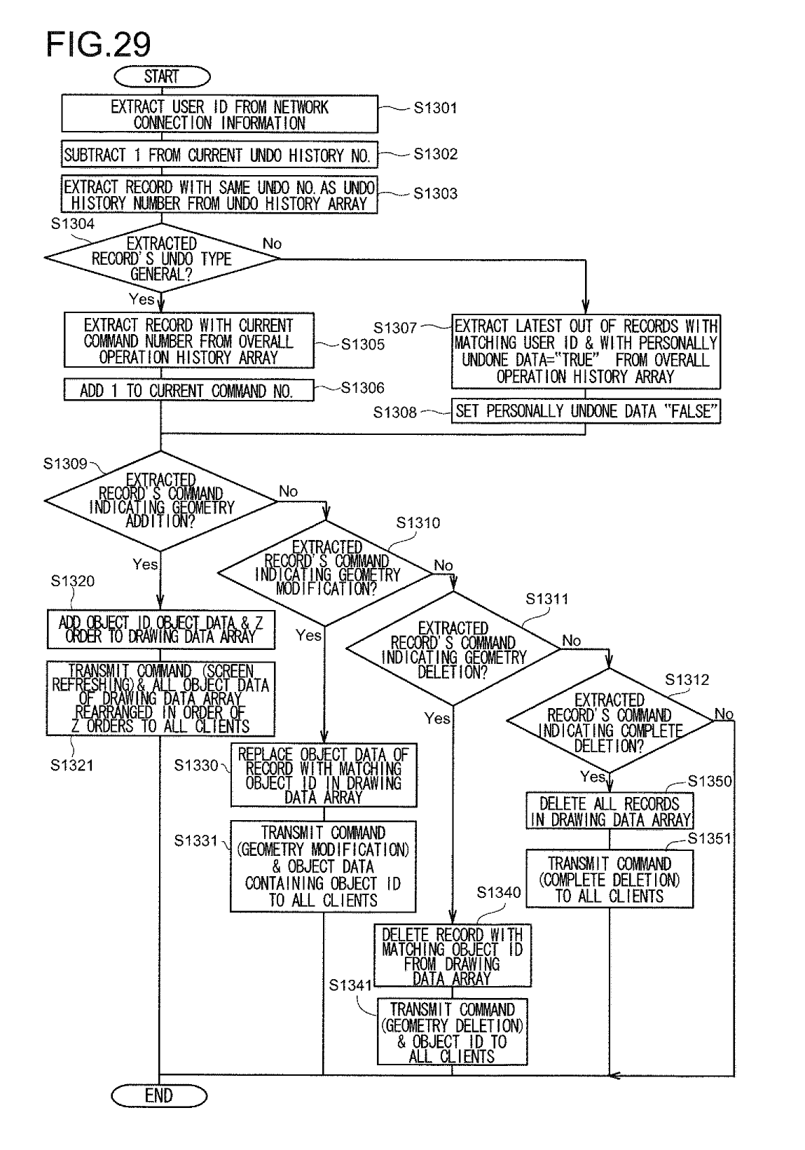

Next, a user of any client 3 can execute a redo process to re-perform a user operation indicated by a command canceled through an undo process. FIG. 29 is a flow chart of the operation of the drawing server in a redo process. Now, with reference to FIG. 29, a redo process will be described.

To cancel the latest undo action, a user selects the undo button 724 on the display screen 7 of client 3A. Moreover, the user selects and enters the redo button 7241c from the undo palette 7241 (see FIG. 8). When the redo button 7241c is selected and entered, client 3A transmits a command (redo) for re-performing a user operation to the drawing server 2.

Based on the network connection information obtained when the command (redo) was received, the drawing server 2 extracts from the drawing space connection array 56 the user ID corresponding to the source of the command (redo) (S1301).

Next, the drawing server 2 subtracts 1 from the current undo history number (S1302). Moreover, the drawing server 2 extracts from the undo history array 53 a record containing the same undo number as the undo history number (S1303). Then, the drawing server 2 checks whether or not the undo type of the extracted record is general undoing (S1304).

If general undoing is recognized (S1304, “Yes”), then the drawing server 2 extracts from the overall operation history array 52 the record (the latest record) having the current command number (S1305). Then, the drawing server 2 adds 1 to the current command number (S1306).

On the other hand, if personal undoing is recognized (S1304, “No”), then the drawing server 2 extracts from the overall operation history array 52 the record (the latest record) having the maximum command number (S1307). Incidentally, this record is extracted out of the records whose command numbers are less than the current command number, whose user ID matches the user ID extracted at S1305, and whose personally undone data is “TRUE.” Then, the drawing server 2 sets the personally undone data of the extracted record to be “FALSE” (S1308).

Next, the drawing server 2 checks what type of geometry handling (geometry addition, geometry modification, geometry deletion, or complete deletion) is indicated by the command of the record extracted at S1305 or S1307. First, the drawing server 2 checks whether or not the command of the extracted record indicates geometry addition (S1309). If geometry addition is found to be indicated (S1309, “Yes”), then an advance is made to S1320, which will be described later, to perform a geometry addition operation through a redo process.

If no geometry addition is found to be indicated (S1309, “No”), then whether or not geometry modification is indicated is checked (S1310). If geometry modification is found to be indicated (S1310, “Yes”), an advance is made to S1330, which will be described later, to perform a geometry modification operation through a redo process.

If no geometry modification is found to be indicated (S1310. “No”), then whether or not geometry deletion is indicated is checked (S1311). If geometry deletion is found to be indicated (S1311, “Yes”), then an advance is made to S1340, which will be described later, to perform a geometry deletion operation through a redo process.

If no geometry deletion is found to be indicated (S1311, “No”), then whether or not complete deletion is indicated is checked (S1312). If complete deletion is found to be indicated (S1312, “Yes”), then an advance is made to S1350, which will be described later, to perform a complete deletion operation through a redo process. Incidentally, if no complete deletion is found to be indicated (S1312, “No”), then the process is ended.

### ((Redo, Geometry Addition))

In a redo process for a geometry addition operation, the drawing server 2 adds to the drawing data array 51 the object ID, the object data, and the pre-execution Z order of the record extracted from the overall operation history array 52 at S1305 or S1307 (S1320). Incidentally, in the user ID of the added record, the user ID extracted at S1301 is registered.

Moreover, the drawing server 2 transmits the command (screen refreshing) and all the object data of the drawing data array 51 rearranged in the order of Z orders to all the clients 3 (S1321). Based on the data received from the drawing server 2, each client 3 refreshes the display screen 7.

### ((Redo, Geometry Modification))

In a redo process for a geometry modification operation, the drawing server 2 replaces, with the object data of the record extracted at S1305 or S1307, the object data of the drawing data array 51 indicated by the object ID of the extracted object ID (S1330).

Moreover, the drawing server 2 transmits to all the clients 3 that have been admitted to the drawing space a command (geometry modification) and the object ID and the object data of the record extracted at S1305 or S1307 (S1331). At this time, the pre-execution Z order may also be transmitted. Each client 3 receives the command (geometry modification) and the object data containing the object data from the drawing server 2, and refreshes the display screen 7 based on the received object data.

### ((Redo, Geometry Deletion))

In a redo process for a geometry deletion operation, the drawing server 2 deletes from the drawing data array 51 the record containing the same object ID as the object ID of the record extracted from the overall operation history array 52 at S1305 or S1307 (S1340).

Moreover, the drawing server 2 transmits to all the clients 3 that have been admitted to the drawing space a command (geometry deletion) and the object ID of the record extracted at S1305 or S1307 (S1341). At this time, no object data is transmitted; null object data may instead be transmitted for it. Each client 3 receives the command (geometry deletion) and the object ID from the drawing server 2, and erases the geometry corresponding to the received object ID from the display screen 7.

### ((Redo, Complete Deletion))

In a redo process for a complete deletion operation, the drawing server 2 deletes all records from the drawing data array 51 (S1350). Then, the drawing server 2 transmits a command (complete deletion of geometries) to all the clients 3 that have been admitted to the drawing space (S1351).

On receiving the command (complete deletion of geometries), each client 3 erases all the geometries displayed on the liquid crystal display 321.

Thus far, the operation of, and the drawing method adopted in, the drawing server 2 of the distributed drawing system 1 have been described. The drawing server 2 is provided with a storage 21 and a CPU 23. The storage 21 stores a drawing data array 51 and an overall operation history array 52. In the drawing data array 51, object data arranged in a drawing space (virtual space) is registered; in the overall operation history array 52, records of individual user operations executed on the object data are accumulated. Based on commands corresponding to user operations, the CPU 23 edits the drawing data array 51 and the overall operation history array 52. The CPU 23 also performs control such that the object data registered in the drawing data array 51 is displayed on a liquid crystal display 321. The records accumulated in the overall operation history array 52 include commands, object data (after user operations), undoing commands (reverse commands), and undoing object data. A command indicates a user operation, and an undoing command (reverse command) indicates an undo operation (reverse operation) for cancelling the user operation. When a command (undo) for cancelling a user operation is executed, the CPU 23 executes an undoing command to display undoing object data on the liquid crystal display 321.

Moreover, according to the above-described drawing method adopted in the drawing server 2, the object data arranged in the drawing space (virtual space) is displayed on the liquid crystal display 321. That is, the drawing data array 51 in which the object data is registered is edited based on commands corresponding to user operations executed on the object data. Also, the overall operation history array 52 is edited based on commands corresponding to user operations. In the overall operation history array 52, records including commands, object data (after user operations), undoing commands, and undoing object data are accumulated on a user operation by user operation basis. Moreover, the object data registered in the drawing data array 51 is displayed on the liquid crystal display 321. Moreover, during display on the liquid crystal display 321, when a command (undo) for canceling a user operation is executed, an undoing command is executed, and undoing object data is displayed on the liquid crystal display 321.

With this configuration, when a command (undo) for canceling a user operation is executed, it is possible, without searching the entire overall operation history array 52, to execute an undoing command and display object data before the user operation on the liquid crystal display 321. In this way, it is possible to synchronize the display screen quickly and perform drawing quickly.

Moreover, with the drawing server 2 described above, when a command (redo) for re-performing a user operation is executed, the CPU 23 executes a command indicating the user operation to display object data after the user operation on the liquid crystal display 321. In this way, when a command (redo) for re-performing a user operation is executed, it is possible, without searching the entire overall operation history array 52, to execute the command indicating the user operation to display the object data after the user operation on the liquid crystal display 321.

Moreover, with the drawing server 2 described above, the records accumulated in the overall operation history array 52 further include user IDs that indicate users who execute user operations on object data. When a command (undo) for canceling a user operation is executed, the CPU 23 executes an undoing command to display undoing object data on the liquid crystal display 321. Incidentally, this operation is performed based on the most recent record out of the records accumulated in the overall operation history array 52 which contain the user ID of the user who executed the command (undo) for cancelling the user operation. In this way, the user can selectively cancel the most recent user operation that the user himself executed. This makes handling of object data easier.

Moreover, in the drawing server 2 described above, when a command (redo) for re-performing a user operation is executed, the CPU 23 executes a command indicating the user operation to display the object data after the user operation on the liquid crystal display 321. This operation is based on the most recent record out of the records accumulated in the overall operation history array 52 which contain the user ID of the user who executed the command (redo) for re-performing the user operation. In this way, after the user has selectively canceled (personally undone) the most recent user operation that the user himself executed, he can then re-perform (redo) that user operation. This makes handling of object data still easier.

Moreover, the drawing server 2 described above is further provided with a communication handler 22 for exchanging data with a client 3. Moreover, the client 3 is provided with at least one of a liquid crystal display 321 and an input device, such as a touch sensor 322, for accepting user operations. The drawing server 2 is connected to the client 3 across a network 4. In this way, it is possible at least either to externally display object data on the client 3 connected across the network 4 or to accept external input through user operations from the client 3.

### (Display Screen Sharing Method)

Next, a description will be given of a display screen sharing method for sharing the display screen 7 among a plurality of clients 3 that are admitted to a drawing space administered by the drawing server 2. In the following description, the client 3 that user B uses will be referred to as client 3B. Moreover, although the following description deals with an example where the display screen 7 is shared between two clients 3A and 3B, needless to say, the display screen 7 can be shared in a similar way by any other client 3 than clients 3A and 38.

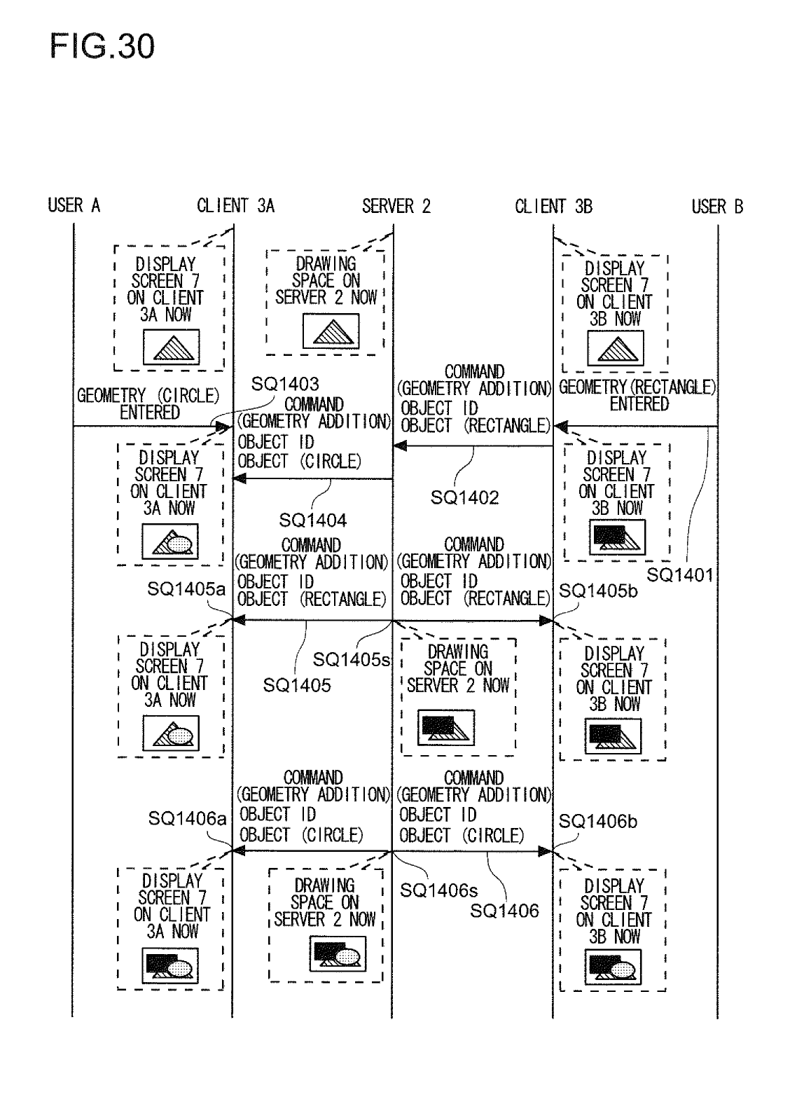

FIG. 30 is a sequence diagram illustrating how the display screen is refreshed on different clients in the first embodiment. In the initial state in FIG. 30, a geometric object (triangle) is arranged in the drawing space, and the geometric object (triangle) is displayed on the display screen 7 of each of clients 3A and 38.

First, on client 3B, user B selects a rectangle geometry sample from the drawing palette 7231 (see FIG. 7) on the display screen 7, and enters the geometry (rectangle) to be added to the drawing space (SQ1401).

At the time point that user B completes a touch operation (for example, at the time point that user B's finger or a touch pen leaves the touch panel 32), client 3B generates an object ID of the entered geometry (rectangle) by using the user ID of user B and a characteristic value unique to it. Moreover, client 3B generates object data of a rectangle (see FIG. 15D) in which the object ID and the vector data extracted from the user input are associated with each other, and displays the generated geometry (rectangle) on the display screen 7. Then, client 3B transmits the geometric object (rectangle) containing the object ID along with a command (geometry addition) to the drawing server 2 (SQ1402).

On the other hand, on client 3A, user A selects a circle geometry sample from the drawing palette 7231 (see FIG. 7) on the display screen 7, and enters the geometry (circle) to be added to the drawing space (SQ1403).

At the time point that user A completes a touch operation, client 3A generates an object ID of the entered geometry (circle) by using the user ID of user A and a characteristic value unique to it. Moreover, client 3A generates object data of a circle (see FIG. 15C) in which the object ID and the vector data extracted from the user input are associated with each other, and displays the generated geometry (circle) on the display screen 7. Then, client 3A transmits the geometric object (circle) containing the object ID along with a command (geometry addition) to the drawing server 2 (S1404). Incidentally, in FIG. 30, SQ1404 is executed after SQ1402.

The drawing server 2 processes the arrangement of objects in the drawing space and the transmission of objects to all clients 3 time-sequentially (in the order in which it receives objects). First, the drawing server 2 performs a geometry addition process based on the command (geometry addition) received from client 3B, and arranges the geometric object (rectangle) in the drawing space (SQ1405s). Then, the drawing server 2 transmits the command (geometry addition) and the geometric object (rectangle) containing the object ID to all the clients 3 that have been admitted to the drawing space (SQ1405).

Client 3A extracts the user ID from the object ID received from the drawing server 2, and checks whether or not the extracted user ID matches the user ID of user A. Here, the two do not match, and therefore client 3A recognizes that the geometric object (rectangle) is not an object transmitted from client 3A. Accordingly, client 3A temporarily stores the received geometric object (rectangle) in the reservoir 331, and does not refresh the display screen 7. That is, client 3A does not display the geometric object (rectangle) on the liquid crystal display 321 (SQ1405a).

On the other hand, client 38 extracts the user ID from the object ID received from the drawing server 2, and checks whether or not the extracted user ID matches the user ID of user B. Here, the two match, and therefore client 38 recognizes that the geometric object (rectangle) is an object transmitted from client 313. Then, based on the received object ID, client 3B erases the geometric object (rectangle) already displayed on the display screen 7, and then displays the received geometric object (rectangle) anew on the display screen 7 (SQ1405b).

Next, the drawing server 2 performs a geometry addition process based on the command (geometry addition) received from client 3A, and arranges the geometric object (circle) in the drawing space (SQ1406s). Then, the drawing server 2 transmits the command (geometry addition) and the geometric object (circle) containing the object ID to all the clients 3 that have been admitted to the drawing space (SQ1406).

Client 3A extracts a user ID from the object ID received from the drawing server 2, and checks whether or not the extracted user ID matches the user ID of user A. Here, the two match, and therefore client 3A recognizes that the geometric object (circle) is an object transmitted from client 3A. Then, based on the received object ID, client 3A for the time being erases the geometric object (circle) already displayed on the display screen 7. Thereafter, client 3A refreshes the display screen 7 to display the geometric object (rectangle) stored in the reservoir 331 and the geometric object (circle). That is, client 3A displays the geometric object (rectangle) retrieved from the reservoir 331 and the geometric object (circle) received from the drawing server 2 time-sequentially (in the order in which they were received from the drawing server 2) (SQ1406a).

On the other hand, at the time point of SQ1405b, client 3B has completed the transmission of the geometric object (rectangle) to be transmitted to the drawing server 2, and in addition client 3B has completed the reception from the drawing server 2 of the geometric object (rectangle) that client 3B transmitted to the drawing server 2. Accordingly, client 3B, without checking the user ID of the geometry (circle), additionally displays the received geometric object (circle) on the display screen 7 (SQ1406b). That is, client 3B neither extracts a user ID from the object ID received at that time, nor makes a check against the user ID of user B.

Through the procedure described above, all the objects arranged in the drawing space are displayed on the display screen 7 of all the clients 3 connected to the drawing server 2. That is, all the clients 3 can share the display screen 7 which is synchronized with the drawing space.

The above description of a display screen sharing method deals with a case where clients 3A and 3B each transmit one object. In a case where clients 3A and 3B each transmit a plurality of objects, for example, a process similar to SQ1406a may be performed when part of transmitted objects have been received, or when all transmitted objects have been received.

Moreover, in the display screen sharing method described above, for example when clients 3A and 3B receive an object from the drawing server 2 immediately after the refreshing of the display screen 7 at SQ1406, the display screen 7 may be refreshed immediately to display the received object. Preferably, the display screen 7 is refreshed a predetermined period (for example, 0.5 seconds) thereafter. That is, objects received during that predetermined period may be temporarily stored in the reservoir 331 so that, after the predetermined period, the objects stored in the reservoir 331 are displayed all together time-sequentially. In this way, it is possible to still more reliably prevent the user from feeling uneasy about apparent loss of displayed objects from the display screen 7, and also to more effectively suppress flicker on the display screen 7.

A method for sharing a display screen among clients 3 in a distributed drawing system 1 according to the first embodiment has been described above. As discussed above, the distributed drawing system 1 is provided with a drawing server 2, and a plurality of clients 3 connected to the drawing server 2. The drawing server 2 has a drawing data array 51 in which object data arranged in a drawing space (virtual space) is registered.

Moreover, each client 3 is a display terminal device that displays the object data arranged in the drawing space on a liquid crystal display 321. Moreover, each client 3 is provided with an ID generator 311, a transmitter-receiver 35, a reservoir 331, and a display controller 313. The ID generator 311 generates an object ID indicating the object data entered by a user of the client 3 such that it contains a user ID indicating the user of the client 3. The transmitter-receiver 35 functions as a transmitter, and transmits the object data entered by the user of the client 3, along with the object ID generated by the ID generator 311, to the drawing server 2. The transmitter-receiver 35 also functions as a receiver, and receives from the drawing server 2 object data and a object ID indicating the object data. The reservoir 331 saves the object data and the object ID received from the drawing server 2 until the object data transmitted from the transmitter-receiver 35 is received by the transmitter-receiver 35. The display controller 313 refreshes the display screen 7 of the liquid crystal display 321 to display the object data received by the transmitter-receiver 35.

Moreover, a display screen sharing method in the above-described the clients 3 is a display screen sharing method among a plurality of clients 3 connected to a drawing server 2 having a drawing data array 51 in which object data arranged in a drawing space (virtual space) is registered. In this display screen sharing method, by use of a user ID indicating a user, a client 3 generates an object ID indicating object data. Moreover, the client 3 transmits the object data entered by the user and the object ID to the drawing server 2. Moreover, the client 3 receives object data and an object ID indicating the object data from the drawing server 2. Moreover, the client 3 saves the object data and the object ID received from the drawing server 2 until the object data transmitted to the drawing server 2 is received from the drawing server 2. Then, the client 3 refreshes the display screen 7 of the liquid crystal display 321 to display the object data received from the drawing server 2.

With the configuration described above, until the object data transmitted from the transmitter-receiver 35 is received by the transmitter-receiver 35, the object data and the object ID received from the drawing server 2 are saved in the reservoir 331. Moreover, the display screen 7 of the liquid crystal display 321 is not refreshed but is retained. That is, when the transmitted object data is received by the transmitter-receiver 35, the display screen 7 of the liquid crystal display 321 is refreshed to display the received object data. Accordingly, even when the display controller 313 refreshes the display screen 7 of the liquid crystal display 321, the object data entered by the user of the client 3 can be displayed in the foreground (topmost layer) on the display screen 7. Thus, even when the object data received from the drawing server 2 is displayed, it is possible to prevent the user from feeling uneasy about apparent loss of the already displayed object data.

Moreover, when the display screen 7 is refreshed, the object data received from the drawing server 2 is displayed all together, and thus operations for displaying object data can be performed at a time. In this way, as compared with in a case where display operations need to be performed a plurality of times, it is possible to further suppress flicker on the display screen 7 and prevent the user from feeling uncomfortable.

Moreover, the client 3 described above is further provided with an ID checker 312. The ID checker 312 checks whether or not the user ID contained in the object ID received from the drawing server 2 matches the user ID of the user of the client 3. If the ID checker 312 finds the user IDs to mismatch, the display controller 313 saves the object data and the object ID received from the drawing server 2 in the reservoir 331. On the other hand, if the ID checker 312 finds the user IDs to match, the display controller 313 refreshes the display screen 7 of the liquid crystal display 321 to display the object data saved in the reservoir 331.

In this way, when the user ID contained in the object ID received from the drawing server 2 matches the user ID of the client 3, the object data and the object ID received from the drawing server 2 are saved in the reservoir 331. The display screen 7 of the liquid crystal display 321 is not refreshed but is retained. When the two mismatch, the display screen 7 of the liquid crystal display 321 is refreshed to display the object data saved in the reservoir 331. Thus, even when the display screen 7 of the liquid crystal display 321 is refreshed, it is possible to more reliably display the object data entered by the user of the client 3 in the foreground (topmost layer) on the display screen 7.

Moreover, in the client 3 described above, when the transmitter-receiver 35 receives object data from the drawing server 2 during a predetermined period after the refreshing of the display screen 7, the display controller 313 saves the object data and the object ID received from the drawing server 2 in the reservoir 331. In this way, for the predetermined period after the refreshing of the display screen 7, the object data and the object ID received from the drawing server 2 are saved in the reservoir 331, and the display screen 7 of the liquid crystal display 321 is not refreshed but is retained. Thus, it is possible to still more reliably prevent the user from feeling uneasy about apparent loss of the already displayed object data upon refreshing of the display screen 7. Moreover, it is possible to more effectively suppress flicker and the like on the display screen 7 due to refreshing of the display screen 7.

### Second Embodiment

Next, a second embodiment will be described. Suppose that, during the period after an objet starts to be entered on the touch panel 32 until the entered object is transmitted to the drawing server 2, the transmitter-receiver 35 receives another object from the drawing server 2. In the second embodiment, in such a case, the display controller 313 of the client 3 further saves the received object in the reservoir 331, and does not refresh the display screen 7. This operation is performed irrespective of the user ID indicated by the object ID of the received object. That is, in this operation, the ID checker 312 does not check the user ID of the received object. Except in these respects, the configuration is the same as in the first embodiment. In the following description, such elements as find their counterparts in the first embodiment are identified by the same reference signs as there, and no overlapping description will be given.

### (Display Screen Sharing Method)

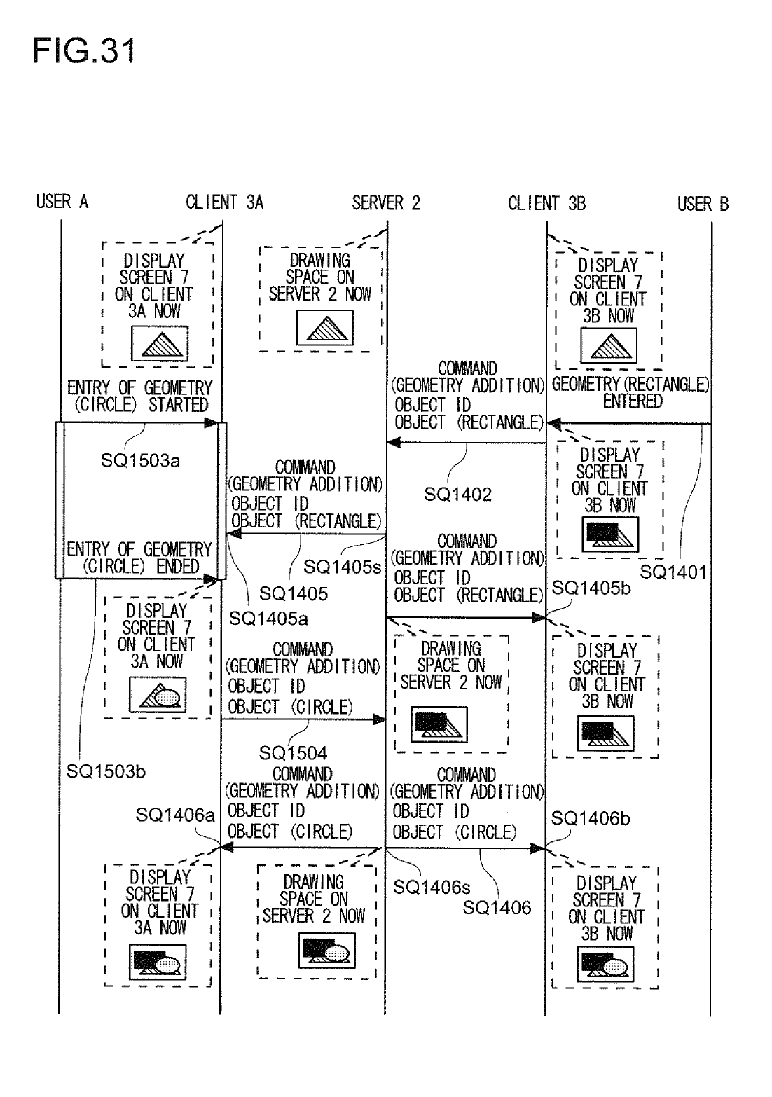

FIG. 31 is a sequence diagram illustrating how a display screen is refreshed on different clients in a second embodiment. In the initial state in FIG. 31, a geometric object (triangle) is arranged in the drawing space, and the geometric object (triangle) is displayed on the display screen 7 of each of clients 3A and 3B.

In the second embodiment, before SQ1405 is performed, on client 3A, user A selects a circle geometry sample from the drawing palette 7231 (see FIG. 7), and starts to enter the geometry (circle) to be added to the drawing space (SQ1503a). Then, after SQ1405 is executed, the entry of the geometry (circle) is ended (SQ1503b).

Thus, at SQ1405a, client 3A saves the geometric object (rectangle) received from the drawing server 2 in the reservoir 331, and does not refresh the display screen 7. At this time, client 3A neither extracts a user ID from the object ID of the geometric object (rectangle), nor checks whether or not the user ID of the geometric object (rectangle) matches the user ID of user A.

Then, at SQ1503b, when user A ends a touch operation, client 3A generates an object ID of the entered geometry (circle) by using the user ID of user A and a characteristic value unique to it. Moreover, client 3A generates object data of the circle (see FIG. 15C) where the object ID and the vector data extracted from the user input are associated with each other, and displays the generated geometry (circle) on the display screen 7.

Then, client 3A transmits the geometric object (circle) containing the object ID along with a command (geometry addition) to the drawing server 2 (SQ1504).

Next, the drawing server 2 performs a geometry addition process based on the command (geometry addition) received from client 3A, and arranges the geometric object (circle) in the drawing space (SQ1406s). Moreover, the drawing server 2 transmits the command (geometry addition) and the geometric object (circle) containing the object ID to all the clients 3 that have been admitted to the drawing space (SQ1406). Then, at SQ1406a, based on the received object ID, client 3A for the time being erases the geometric object (circle) already displayed on the display screen 7. Thereafter, client 3A refreshes the display screen 7 to display the geometric object (rectangle) retrieved from the reservoir 331 and the geometric object (circle). Moreover, at SQ1406b, without checking the user ID of the geometric object (circle), client 3B additionally displays the received geometric object (circle) on the display screen 7.

The operation of, and the display screen sharing method adopted in, the client 3 in the distributed drawing system 1 according to the second embodiment have been described above. As described above, in the second embodiment, while the user of the client 3 is editing the object data displayed on the liquid crystal display 321, the reservoir 331 saves the object data and the object ID received from the drawing server 2. In this way, while the user is editing object data, object data and an object ID received from the drawing server 2 are saved in the reservoir 331, and the display screen 7 of the liquid crystal display 321 is not refreshed but is retained. Thus, it is possible to more reliably prevent the user from feeling uneasy about apparent loss of the already displayed object data upon refreshing of the display screen 7. It is also possible to more effectively suppress flicker and the like due to refreshing of the display screen 7.

Embodiments of the present invention have been described above. The embodiments described above are merely illustrative, and those with ordinary skill in the art would understand that many modifications are possible with respect to how individual elements and processes are combined together within the scope of the present invention.

For example, although in the first and second embodiments described above, the ID generator 311, the ID checker 312, and the display controller 313 are realized as functional elements of the CPU 31, the scope of application of the present invention is not limited by that specific example. All or part of them may instead be realized as physical elements such as electronic circuits.

Although in the first and second embodiments described above, both the process from log-in to admission to a drawing space and the administration of the drawing space are handled by the same drawing server 2, they may instead be handled by separate servers. In that case, the drawing space list which a client obtains upon admission (see FIG. 18) contains URLs to a drawing space and to a drawing server 2. Instead, the result of the drawing space admission process may contain URLs to a drawing space and to a drawing server 2.

Although in the first and second embodiments described above, WebSocket is used as a protocol in drawing spaces, any other protocol similar to it may instead be used.

Although the first and second embodiments described above deal with examples where the present invention is applied to a distributed drawing system 1, the present invention may be applied to drawing devices incorporating a display terminal device (for example, the client 3). In other words, the present invention may be applied to drawing devices provided with a display terminal unit that functions as a display terminal device (for example, a client 3), or to display terminal devices provided with a drawing unit that functions as a drawing device (for example, a drawing server 2).

Although the first and second embodiments described above deal with examples where the display terminal device (for example, the client 3) is provided with a wireless LAN antenna 36, this may be used together with, or replaced with, a wired LAN antenna or a mobile communication network antenna.

What is claimed is:

1. A display terminal device for displaying object data arranged in a virtual space on a display device, comprising:
an identifier generator for generating an object identifier indicating object data entered by a user of the display terminal device such that the object identifier includes a user identifier indicating the user;
a transmitter for transmitting object data entered by the user and the object identifier generated by the identifier generator to a drawing device;
a receiver for receiving object data and an object identifier indicating the object data from the drawing device;
a reservoir for saving the object data and the object identifier received from the drawing device until the object data transmitted from the transmitter is received by the receiver; and
a display controller for refreshing a display screen of the display device to display the object data received by the receiver.

2. The display terminal device according to claim 1, further comprising an identifier checker for checking whether or not the user identifier included in the object identifier received from the drawing device matches the user identifier of the user, wherein
when the identifier checker finds that the user identifiers mismatch, the display controller saves the object data and the object identifier received from the drawing device in the reservoir, and
when the identifier checker finds that the user identifiers match, the display controller refreshes the display screen of the display device to display the object data saved in the reservoir.

3. The display terminal device according to claim 1, wherein the reservoir saves the object data and the object identifier received from the drawing device while the user is editing the object data displayed on the display device.

4. The display terminal device according to claim 1, wherein when the receiver receives the object data from the drawing device during a predetermined period after refreshing of the display screen, the display controller saves the object data and the object identifier received from the drawing device in the reservoir.

5. The display terminal device according to claim 1, further comprising a drawing unit which functions as the drawing device, wherein
the drawing unit includes
a storage for storing a drawing database in which object data arranged in the virtual space is registered and an operation history database in which a record of each user operation executed on the object data is accumulated, and
a controller for editing the drawing database and the operation history database based on a command corresponding to a user operation, and for displaying the object data registered in the drawing database on the display device,
the record accumulated in the operation history database includes a command indicating the user operation, object data after the user operation, a reverse command for a reverse operation for cancelling the user operation, and object data before the user operation, and
when the command for canceling the user operation is executed, the controller executes the reverse command to display the object data before the user operation on the display device.

6. The display terminal device according to claim 5, wherein, when a command for re-performing the user operation is executed, the controller executes a command indicating the user operation to display the object data after the user operation on the display device.

7. The display terminal device according to claim 5, wherein
the record accumulated in the operation history database further includes a user identifier indicating a user who executes the user operation on the object data, and
when the command for canceling the user operation is executed, the controller executes the reverse command to display the object data before the user operation on the display based on a most recent record out of records accumulated in the operation history database which include a user identifier of a user who executed the command for canceling the user operation.

8. The display terminal device according to claim 7, wherein when the command for re-performing the user operation is executed, the controller executes the command indicating the user operation to display the object data after the user operation on the display device based on a most recent record out of records accumulated in the operation history database which include a user identifier of a user who executed the command for re-performing the user operation.

9. The display terminal device according to claim 5, wherein
the drawing unit further includes a communication handler for exchanging data with another display terminal device provided with at least one of the display device and an input device for accepting the user operation, and
the display terminal device is connected to the another display terminal device across a network.

10. A display screen sharing system comprising:
a plurality of display terminal devices, each according to claim 1; and
a drawing device connected to the plurality of display terminal devices.

11. The display screen sharing system according to claim 10, wherein
the display terminal devices each include at least one of the display device and an input device for accepting the user operation, and
the drawing device further includes a communication hander for exchanging data with the display terminal devices, and is connected to the display terminal devices across a network.

12. A method of sharing a display screen among a plurality of display terminal devices connected to a drawing device having a drawing database in which object data arranged in a virtual space is registered, comprising:
a generating step in which a display terminal device generates an object identifier indicating object data entered by a user such that the object identifier includes a user identifier indicating the user;
a transmitting step in which the display terminal device transmits the object data entered by the user and the object identifier generated in the generating step to the drawing device,
a receiving step in which the display terminal device receives object data and an object identifier indicating the object data from the drawing device;
a saving step in which the display terminal device saves the object data and the object identifier received from the drawing device until the display terminal device receives the object data that the display terminal device transmitted in the transmitting step; and
a refreshing step in which the display terminal device refreshes a display screen on a display device to display the object data received in the receiving step.

13. The method of sharing a display screen according to claim 12, further comprising:
a first editing step in which the drawing device edits the drawing database based on a command corresponding to a user operation executed on the object data arranged in the virtual space;
a second editing step in which the drawing device edits an operation history database, in which for each user operation a record including a command indicating the user operation, object data after the user operation, a reverse command indicating a reverse operation for canceling the user operation, and object data before the user operation is accumulated, based on a command corresponding to the user operation; and
a displaying step in which the drawing device displays the object data registered in the drawing database on the display device, wherein
the displaying step includes a step in which, when the command for canceling the user operation is executed, the drawing device executes the reverse command to display the object data before the user operation on the display device.
